(19) United States
(12) Patent Application Publication
(10) Pub. No.: US 2025/0081047 A1
(43) Pub. Date: Mar. 6, 2025

(54) Managing Quality of Experience Reporting

(71) Applicant: GOOGLE LLC, Mountain View, CA (US)

(72) Inventors: Chih-Hsiang Wu, Taoyuan City (TW); Teming Chen, Taoyuan City (TW)

(21) Appl. No.: 18/293,945

(22) PCT Filed: Aug. 5, 2022
(86) PCT No.: PCT/US2022/039532

§ 371 Date: Jan. 31, 2024

Related U.S. Application Data
(60) Provisional application No. 63/229,811, filed on Aug. 5, 2021.

(51) Int. Cl. H04W 36/00

(52) U.S. Cl. CPC H04W 36/0044; H04W 36/0058

(57) ABSTRACT

A radio access network (RAN); a core network (CN) or operations, administration, and management (OAM) node; and a user equipment (UE) can implement a method for managing Quality of Experience (QoE) reporting from the UE. The method includes: facilitating QoE reporting to a QE node for the UE; determining to perform a handover for the UE from a source node of the RAN to a target node of the RAN; and pausing the QoE reporting. The method may further providing information to identify a QoE configuration of multiple configurations. The information may include QoE configurations, reference identifiers, QoE configuration identifiers, and information about associations between the reference identifiers and the QoE configuration identifiers.

### FIELD OF THE DISCLOSURE

This disclosure relates to a wireless communications system, more particularly, to a wireless communications system that manages quality of experience measurement collection and reporting during mobility and/or state transition.

### BACKGROUND

In a wireless communication system, a base station that supports a certain Radio Access Technology (RAT) communicates with a user equipment (UE) using, among other protocols, a protocol for controlling radio resources corresponding to the RAT. The protocol for controlling radio resources may be, for example, a Radio Resource Control (RRC) protocol utilized by 4G, 5G, 6G, or later-generation wireless communication systems. Upon establishing a radio connection via the base station, the UE operates in a connected state of the protocol for controlling radio resources, which may be RAT-specific (e.g., EUTRA-RRC CONNECTED, NR-RRC CONNECTED).

Mobile networks evolve to improve the user experience. As such, the evaluation of the user experience at the UE side is useful to network operators. In particular, such evaluation is useful when operators provide real-time services which require, for example, high date rate and low latency, where even intermittent quality degradation may degrade a user's experience. Such real-time services include streaming services (typically video services), Multimedia Telephony Service for Internet Multimedia Subsystem (IMS) (MTSI), Multicast and/or Broadcast Service (MBS), and/or extended reality (XR) services. Many of these services are a part of the commercial traffic growth rate, and therefore the focus is on the end user's experience.

Generally speaking, Quality of Experience (QoE) measurement collection (QMC) provides detailed information for a UE, at a call (also called “application session”) level. These measurements can provide information which a network operator cannot derive based on RAN or CN measurements. A UE can collect QoE information and provide to a management system for analysis and/or key performance indicator (KPI) calculations.

In LTE systems, the QMC function enables collection of application layer measurements from the UE. The supported service types can include streaming services and MTSI services. A Trace Function from the Minimization of Drive Tests (MDT) framework activates the QMC. LTE supports signaling-based and management-based initiation cases. For the signaling-based case, the Application Layer Measurement Collection is initiated toward a specific UE from CN nodes using an MDT mechanism. For the management-based case, the Application Layer Measurement Collection is initiated from an operations, administration, and management (OAM) node targeting an area (without targeting a specific UE).

As described in 3GPP specifications 28.405 v16.0.0, 36.300 v16.6.0, and 36.331 v16.5.0, a transparent container encapsulates an application layer measurement configuration received from an OAM node or CN, which a radio access network (RAN) forwards to a UE in a downlink RRC message. The RAN encapsulates application layer measurements received from the UE's higher layer in a transparent container and sends the measurements to the network in an uplink RRC message. The application layer measurement configuration and measurement reporting are supported in RRC_CONNECTED state only. E-UTRAN can release the application layer measurement configuration toward the UE at any time.

### SUMMARY

A network node implements QMC and supports configuration and reporting for multiple simultaneous QoE measurements, for the same or different service types, for a UE. To identify the measurements and support activation, modification, and release functionality, a RAN node uses a mapping between reference IDs and QoE configurations.

Further, the RAN in some cases can initiate pausing and resuming for one or more QoE configurations. More particularly, the RAN can the pause and resume functions in handover scenarios. The RAN also can support pausing and resuming initiated by a QoE node, such as the OAM, during handover scenarios.

One example embodiment of these techniques is a method for managing quality of experience (QoE) reporting, implemented in a radio access network (RAN). The method includes facilitating, by processing hardware, reporting of QoE measurements for a user equipment (UE), to a QoE node; determining, by the processing hardware, to perform a handover of the UE from the source node to a target node in the RAN; and subsequently to the determining, transmitting a pause status for the reporting.

Another example embodiment of these techniques is a method for managing QoE reporting, implemented in a source node in a RAN. The method includes facilitating, by processing hardware, reporting of QoE measurements to a QoE node according to a plurality of QoE configurations, for a UE; determining, by the processing hardware, to perform a handover of the UE from the source node to a target node in the RAN; and providing, by the processing hardware to the target node and in response to the determining, identification information to identify a QoE configuration within the plurality of QoE configurations.

Still another example embodiment of these techniques is a method for managing QoE reporting, implemented in a target node of a RAN. The method includes receiving, by the processing hardware, a plurality of QoE configurations associated with reporting QoE measurements to a QoE node from a UE; facilitating, by the processing hardware, a handover of the UE from a source node of the RAN to the target node according to the plurality of QoE configurations; and receiving, by the processing hardware at the target node and in response to the handover, identification information to identify a QoE configuration within the plurality of QoE configurations.

Yet another example embodiment of these techniques is a method for managing QoE reporting, implemented in a UE. The method includes reporting, by processing hardware, QoE measurements to a QoE node via a RAN; receiving, by the processing hardware, a command to perform a handover from a source cell of the RAN to a target cell in the RAN; and determining, by the processing hardware, whether to pause the reporting during the handover, based on an indication received from the RAN.

Still yet another example embodiment of these techniques is a method for managing QoE reporting, implemented in a QoE node operating in, or in communication with, a core network (CN). The method includes receiving, by processing hardware, QoE measurements from a UE via a source node of a RAN; transmitting, by the processing hardware to the UE via the RAN, a command to change a pause status of reporting of the QoE measurements; receiving, by the processing hardware from the RAN, an indication that the pause status has not changed; and in response to determining that the UE has completed a handover from a source cell to a target cell, re-transmitting the command to change the pause status.

### BRIEF DESCRIPTION OF THE DRAWINGS

FIG. 1A is a block diagram of an example system in which a base station and/or a user equipment (UE) can implement the techniques of this disclosure for managing quality of experience (QoE) measurement collection and reporting in a UE;

FIG. 1B is a block diagram of an example base station including a central unit (CU) and a distributed unit (DU) that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with one or more base stations using a distributed architecture;

FIG. 3A illustrates an example scenario in which a RAN completes a handover procedure, for a UE that is performing quality of experience (QoE) measurement collection (QMC) and reporting, before releasing a QoE configuration;

FIG. 3B illustrates a scenario similar to that of FIG. 3A, but in which the RAN transmits a command to the UE to modify the QoE configuration rather than a release command;

FIG. 3C illustrates a scenario similar to that of FIG. 3A, but in which the source base station transmits the QoE configurations to the target base station via a core network (CN) or operations, administration, and management (OAM) node;

FIG. 3D illustrates an example scenario in which the RAN pauses QoE reporting at the source base station before performing the handover procedure and resumes the QoE reporting at the target base station after performing the handover procedure;

FIG. 3E illustrates a scenario similar to that of FIG. 3D, but in which a source base station determines to pause and release the QoE reporting rather than a CN or OAM node;

FIG. 3F illustrates a scenario similar to that of FIG. 3D, but in which preparation for the handover rather than a determination by the RAN or CN/OAM node triggers the resume process;

FIG. 3G illustrates a scenario similar to that of FIG. 3D, but in which the target base station determines to resume the QoE reporting during the handover procedure and transmits an indication to resume to the source base station in response;

FIG. 3H illustrates a scenario similar to that of FIG. 3G, but in which a CN or OAM node handles the handover for the RAN;

FIG. 3I illustrates a scenario similar to that of FIG. 3D, but in which the CN or OAM node attempts to transmit a pause command to the source node but receives an indication that QoE pausing has failed and subsequently transmits a QoE pause command to the target base station;

FIG. 3J illustrates a scenario similar to that of FIG. 3D, but in which the CN or OAM node attempts to transmit a resume command to the source node but receives an indication that QoE resumption has failed and subsequently transmits a QoE resume command to the target base station;

FIG. 4A is a flow diagram of an example method for performing a handover operation between a source node of a RAN and a target node of the RAN for a UE performing QMC and reporting, implemented in a base station;

FIG. 4B is a flow diagram of an example method similar to that of FIG. 4A, but in which the source base station transmits data to a CN or OAM node to perform the handover operation, implemented in a base station;

FIG. 5 is a flow diagram of an example method for transmitting QoE configurations and associated IDs to a UE and further determining whether to release a QoE configuration based on whether a reference ID was included in previously received IDs, implemented in a base station;

FIG. 6 is a flow diagram of an example method for transmitting a QoE pause command to temporarily stop the UE from QoE reporting and subsequently transmitting a pause status indication to a target node of the RAN for handover, implemented in a base station;

FIG. 7 is a flow diagram of an example method for performing a handover for a UE and determining whether to include a QoE pause status indication or a QoE resume indication in a handover message, implemented in a base station;

FIG. 8A is a flow diagram of an example method for determining to and subsequently transmitting a command to the UE to resume QoE reporting after performing a handover, implemented in a base station;

FIG. 8B is a flow diagram of an example method similar to FIG. 8A, but in which the base station transmits a QoE resume indication to the UE in a handover message, implemented in the UE;

FIG. 9 is a flow diagram of an example method for determining whether to resume QoE reporting based on whether the base station receives a QoE pause status indication associated with the QoE configuration, implemented in a base station;

FIG. 10 is a flow diagram of an example method for determining whether to pause or resume QoE reporting in accordance with a QoE configuration after performing a handover procedure, implemented in a RAN;

FIG. 11A is a flow diagram of an example method for receiving a command to pause QoE reporting and subsequently determining whether to resume QoE reporting based on whether the UE receives a QoE resume indication or a QoE configuration, implemented in a UE;

FIG. 11B is a flow diagram of an example method similar to FIG. 11A, but in which the UE resumes QoE reporting in response to performing a handover and without receiving a QoE resume indication, implemented in a UE;

FIG. 12 is a flow diagram of an example method for determining whether to pause QoE reporting or continue in accordance with a QoE configuration based on whether the UE receives a QoE pause indication for the QoE configuration, implemented in a UE;

FIG. 13 is a flow diagram of an example method for determining whether to assign a configuration ID to a reference ID based on whether the RAN has a configuration ID for the reference ID, implemented in a RAN;

FIG. 14 is a flow diagram of an example method for determining whether to activate QoE reporting or update a QoE configuration, and subsequently whether to send QoE reports for the updated QoE configuration based on whether the UE receives a pause indication, a resume indication, or no status indication, implemented in a UE;

FIG. 15 is a flow diagram of an example method for managing QoE reporting by pausing QoE reporting in response to a handover, implemented in a RAN;

FIG. 16 is a flow diagram of an example method for managing QoE reporting by providing information to a target node to identify a QoE configuration flow, implemented in a base station;

FIG. 17 is a flow diagram of an example method for managing QoE reporting by receiving information from a source node to identify a QoE configuration flow, implemented in a base station;

FIG. 18 is a flow diagram of an example method for managing QoE reporting by receiving an indication to pause QoE reporting before completing a handover, implemented in a UE; and

FIG. 19 is a flow diagram of an example method for managing QoE reporting by receiving an indication of a handover for a UE and transmitting an indication to pause QoE reporting, implemented in a CN or an OAM node.

### DETAILED DESCRIPTION

A UE, a source node of a RAN, a target node of a RAN, a core network, and/or an operations, administration, and management (OAM) node implement the techniques of this disclosure to manage QoE measurement and reporting during mobility. The UE 102 may receive commands to pause and/or resume QoE reporting during a handover process. Alternatively, the UE 102 may itself determine to pause and/or resume QoE reporting during a handover process. Further, the UE 102 may receive multiple QoE configurations and operate QoE reporting accordingly.

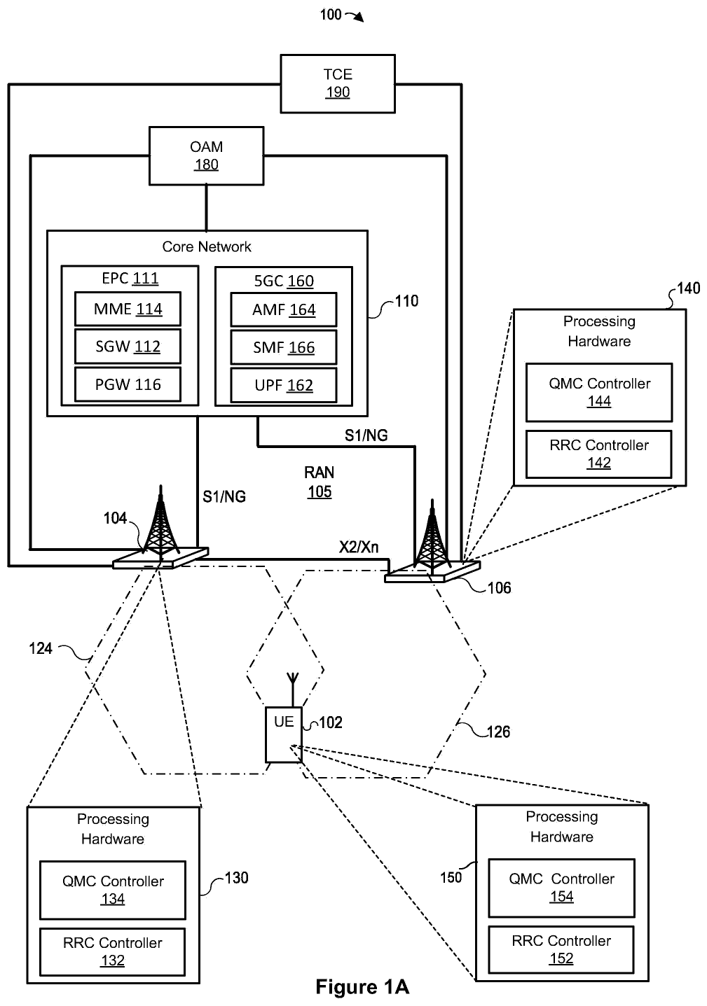

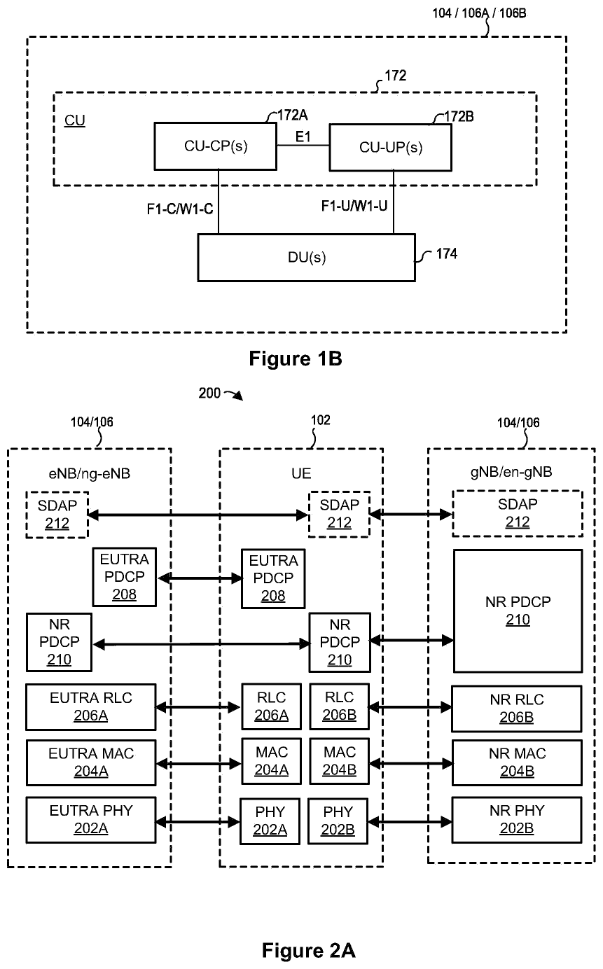

In particular, referring first to FIG. 1A, an example wireless communication system 100 includes a UE 102, a source base station (S-BS) 104, a target base station (T-BS) 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The source base station 104 covers a cell 124, and the target base station 106 covers a cell 126. If the source base station 104 is a gNB, the cell 124 is an NR cell. If the base station 124 is an ng-eNB, the cell 124 is an evolved universal terrestrial radio access (E-UTRA) cell. Similarly, if the target base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the source base station 104 supports a cell 124, and the target base station 106 supports a cell 126. The cells 124 and 126 can partially overlap, so that the UE 102 can select, reselect, or hand over from one of the cells 124 and 126 to the other. To directly exchange messages or information, the source base station 104 and target base station 106 can support an X2 or Xn interface. In general, the CN 110 can connect to any suitable number of base stations supporting NR cells and/or EUTRA cells.

Source base station 104 and UE 102 establish a connection via which the UE 102 and the source base station 104 transmit data payload, e.g., wirelessly. Upon establishing the connection via source base station 104, UE 102 is in a connected state of the RAT protocol for controlling radio resources (e.g., EUTRA-RRC_CONNECTED, NR-RRC CONNECTED). Source base station 104 maintains a context of UE 102, where the context of the UE 102 includes configuration and other information associated with the connection of UE 102 with source base station 104. The context of UE 102 may include configurations of an SRB1, an SRB2, an SRB4, a DRB, and/or other configurations (e.g., security configuration) associated with the connection between UE 102 and source base station 104.

At some point in time, UE 102 establishes, resumes, or re-establishes a radio connection with target base station 106 for servicing. This may occur in various scenarios. In one scenario (“the handover scenario”), source base station 104 may determine that UE 102 is to handover to target base station 106. In another scenario (“the re-establishment scenario”), UE 102 may detect radio link failure (RLF) over the established connection with source base station 104 or detect integrity check failure on the SRB1, SRB2 or SRB4, and subsequently select target base station 106 for servicing. In yet another scenario (“the re-selection scenario”), source base station 104 may detect that below-threshold or no-data activity for UE 102 has occurred over some interval of time over the established connection. Upon this detection, source base station 104 instructs UE 102 to enter into an inactive state of the RAT protocol (e.g., EUTRA-RRC INACTIVE, NR-RRC INACTIVE). At some point in time thereafter, such as when UE 102 has moved into a different coverage area and has payload data to transmit to the system, UE 102 (which is in the inactive state) selects or reselects target base station 106 for servicing.

The source base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes an RRC controller 132 to implement procedures and messaging at the RRC sublayer of the protocol communication stack. The processing hardware 130 can also include a QMC controller 134 configured to manage QoE configuration(s) and QoE reports for one or more UEs. The target base station 106 can include generally similar components. In particular, components 142 and 144 can be similar to the components 132 and 134, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC controller 152 to implement procedures and messaging at the RRC sublayer of the protocol communication stack. The processing hardware 150 can also include a QMC controller 154 configured to manage QoE configuration(s), QMC, and reporting.

FIG. 1B depicts an example distributed or disaggregated implementation of any one or more of the base stations 104, 106. In this implementation, the source base station 104A, 104B. 106A, or 106B includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller; an RRC controller; and/or a paging controller such as PDCP controller 134, 144; RRC controller 136, 146; and/or paging controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that host the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can connect to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. If the CU-CP and DU(s) belong to a gNB, the CU-CP 172A can connect to one or more DU 174s through an F1-C interface and/or an F1-U interface. If the CU-CP and DU(s) belong to a ng-eNB, the CU-CP 172A can connect to one or more DU 174s through a W1-C interface and/or a W1-U interface. In some implementations, one DU 174 can connect to multiple CU-UPs 172B under the control of the same CU-CP 172A. In such implementations, the CU-CP 172A establishes the connectivity between a CU-UP 172B and a DU 174 using Bearer Context Management functions.

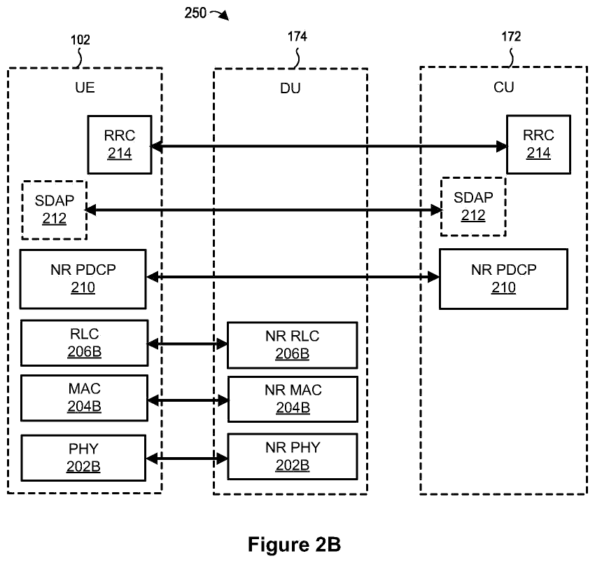

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack, as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

Thus, it is possible to functionally split the radio protocol stack, as shown by the radio protocol stack 250 in FIG. 2B. The CU can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU 174. To support connection to a 5GC, NR PDCP 210 provides SRBs to RRC 214, and NR PDCP 210 provides DRBs to SDAP 212 and SRBs to RRC 214.

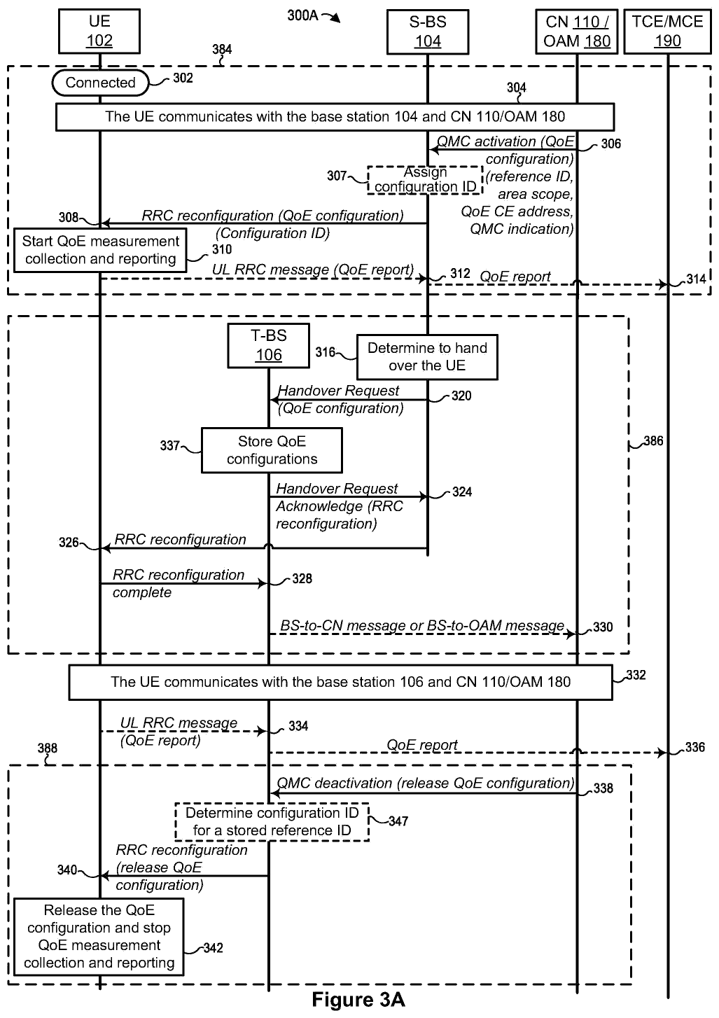

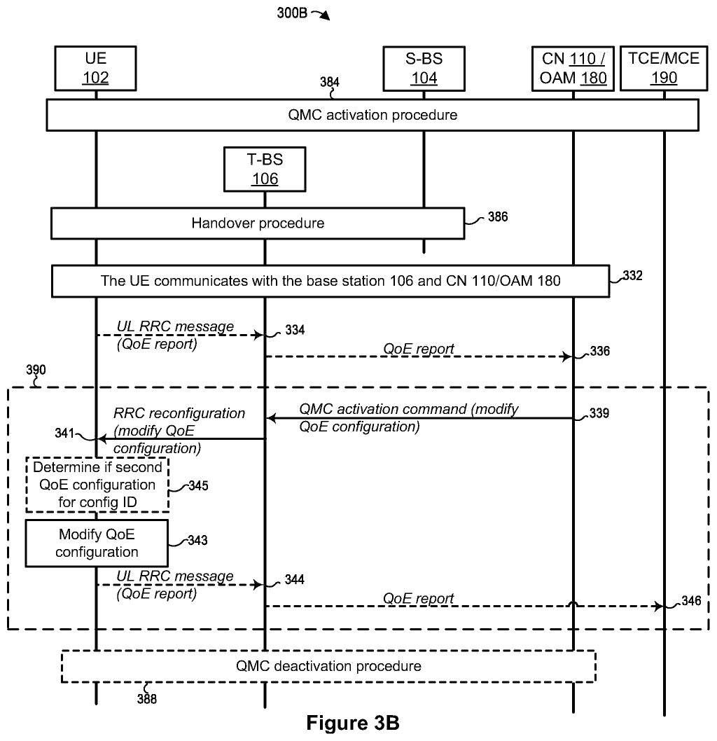

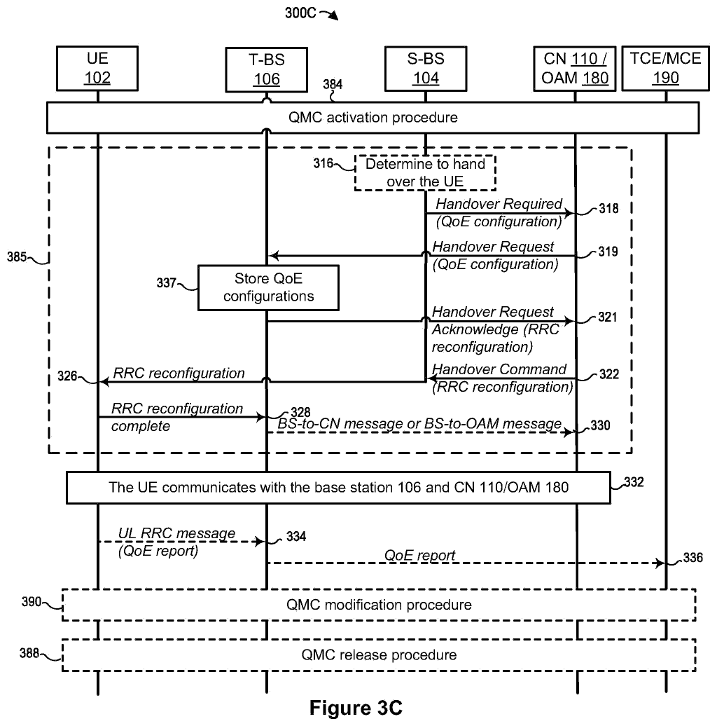

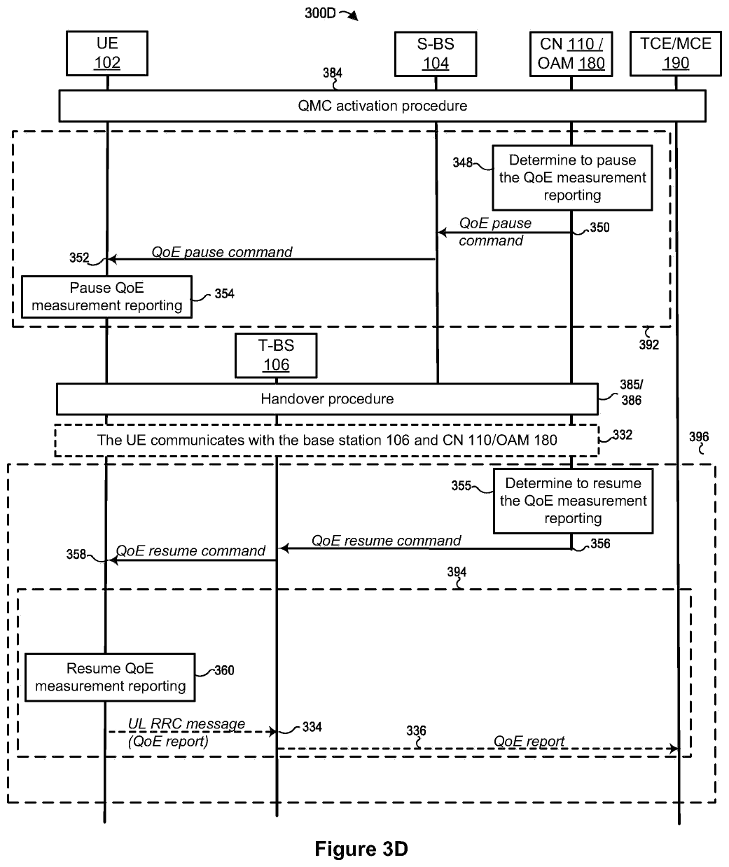

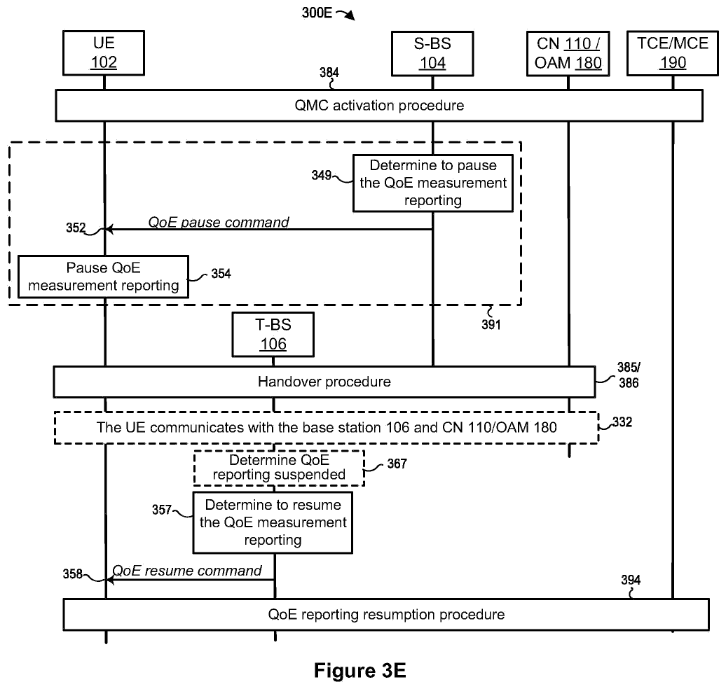

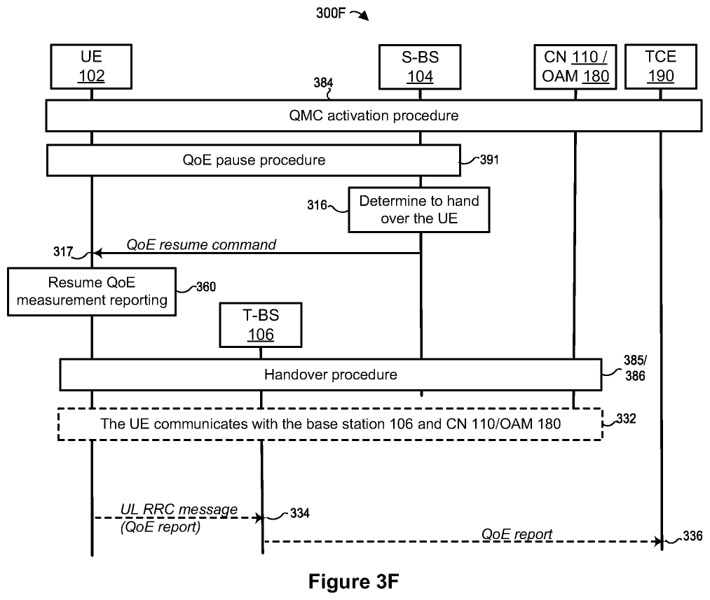

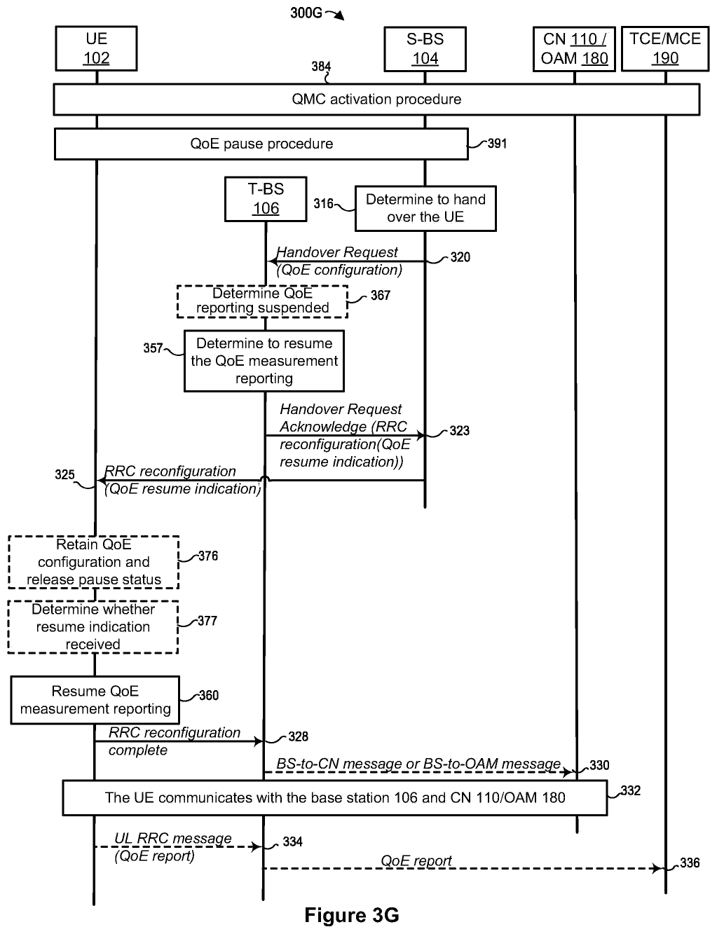

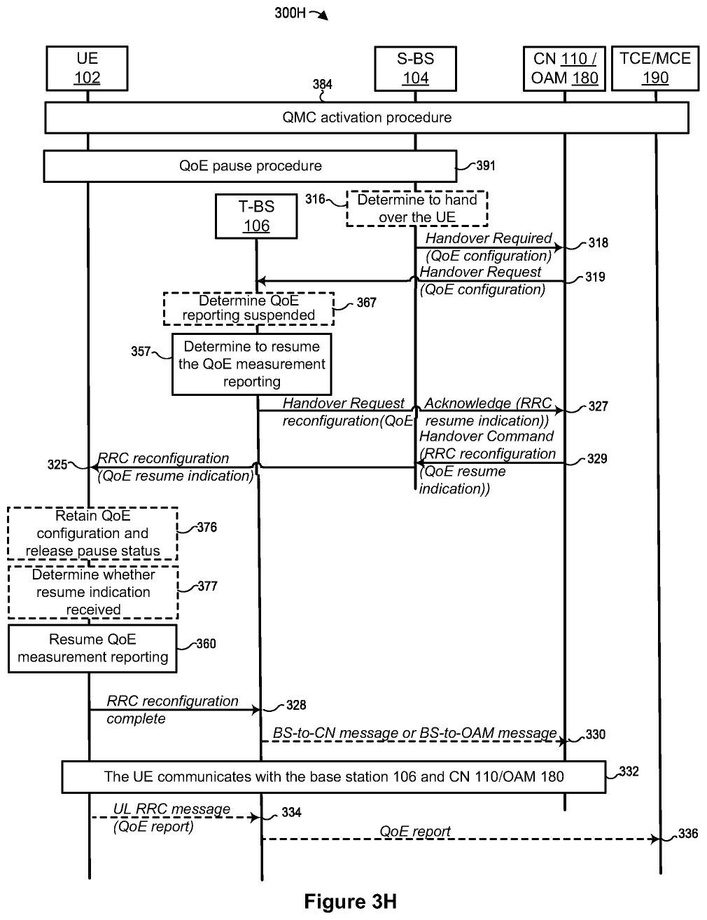

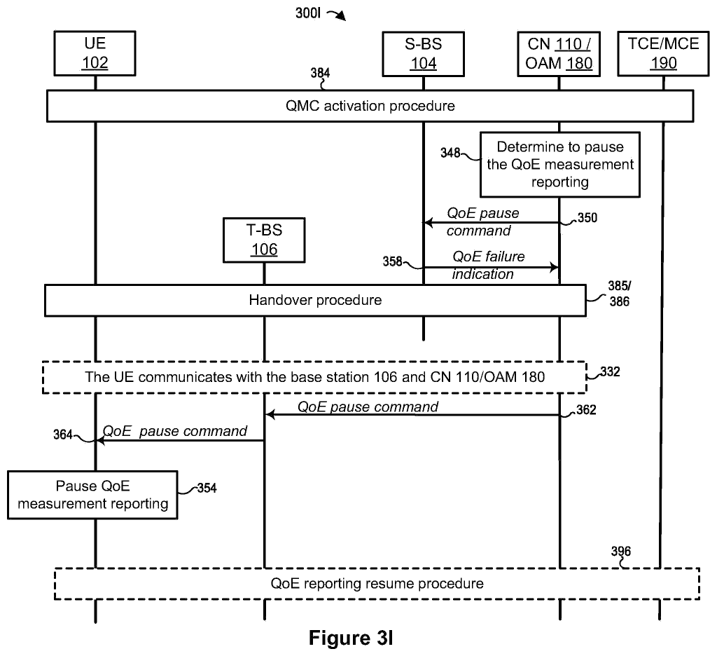

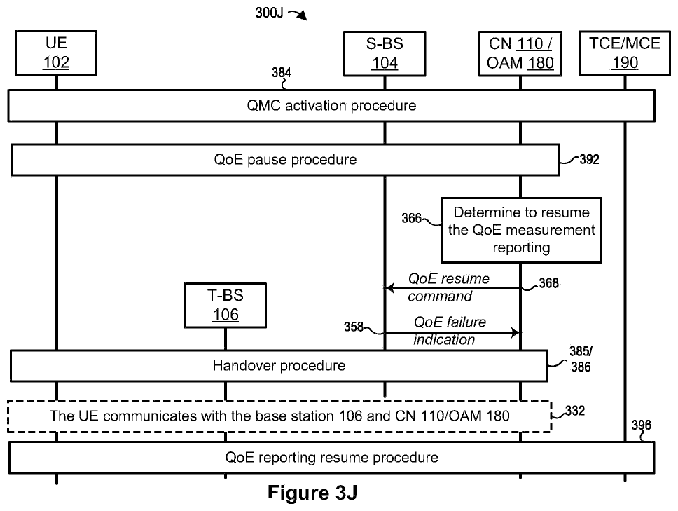

FIGS. 3A-3J are message sequences of example scenarios in which a RAN facilitates Quality of Experience (QoE) measurement collection (QMC) and reporting for a UE and a CN or OAM node during mobility. Generally speaking, equivalent events in FIGS. 3A-3J are labeled with similar reference numbers (e.g., event 384 in FIG. 3A is similar to event 384 in FIGS. 3B-3J) with differences discussed below where appropriate. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

Referring first to FIG. 3A, in a scenario 300A, the UE initially operates 302 in a connected state (e.g., RRC_CONNECTED) with a source base station 104 of a RAN 105. While in the connected state, the UE 102 communicates 304 with the source base station 104 and a CN 110. The CN 110 or an OAM node 180 transmits 306 to the source base station 104 a command to activate QMC and reporting for the UE 102. Depending on the implementation, the QMC activation command may also include a particular reference identifier, such as a reference ID, identifying the QoE configuration. In implementations in which the QMC does not include a particular reference ID, the Trace ID may be used to identify the QoE configuration. In other implementations, the CN 110 or OAM 180 transmits the one or more QoE configurations and/or any other information elements described above to the source base station 104 while communicating 304 with the source base station 104 and the UE 102.

In some implementations, the QMC activation is a Trace Start message (e.g., as defined in TS 32.421). In further implementations, the QMC activation command is included in an OAM-to-BS message or a CN-to-BS message, such as a next generation application protocol (NGAP) message. The CN 110 or OAM 180 may transmit 306 the CN-to-BS message or OAM-to-BS message, respectively, including the QMC activation command to the source base station 104. Depending on the implementation, the activation command includes, one or more QoE configurations, configuration identifiers (i.e., configuration IDs), reference identifiers (i.e., reference IDs), Trace IDs, Interfaces to Trace IE, Trace Depth IE, TCE IP Address (i.e., qoEReference), UE address (i.e., qoECollectionEntityAddress), an indication of the QMC activation and/or pause status, and/or the TCE URI as interface IEs in the activation command. (e.g., as defined in TS 32.421). Depending on the implementation, variables and functions with similar features may be named differently. In some implementations, the activation command includes IEs describing area information (i.e., areaScope). In implementations in which the QMC activation command includes more than one QoE configuration, the CN 110 or OAM 180 includes particular reference IDs for the QoE configurations in the QMC activation command. Depending on the implementation, the reference IDs may have the same or different values. In some implementations, the CN 110 or OAM 180 generates the reference IDs, and in other implementations, the RAN 105 generates and/or assigns 307 the reference IDs.

In some implementations, the one or more QoE configurations are associated with the first Trace ID. In other implementations, the CN 110 or OAM 180 includes additional Trace IDs for additional QoE configurations beyond the first QoE configuration in the QMC activation command. Depending on the implementation, there may be an additional Trace ID for each of the additional QoE configurations, or multiple QoE configurations may be associated with a single Trace ID. The CN 110 or OAM 180 can generate each Trace ID with a different value.

The source base station 104 then transmits 308 a message to the UE 102 to reconfigure radio resources for the UE 102, such as an RRC reconfiguration message. The UE 102 can transmit a “complete” message to the base station 104, such as an RRC reconfiguration complete message (not shown), in response to the message 308. In some implementations, the source base station 104 generates a QoE configuration identifier, such as a QoE configuration ID, associated with the first QoE configuration and/or the first reference ID. The source base station 104 can also generate a particular QoE configuration ID for each of the QoE configurations and/or reference IDs. In further implementations, the source base station 104 includes the one or more QoE configurations in the reconfiguration message. In other implementations, the source base station 104 may transmit the one or more QoE configurations to the UE 102 while communicating 304 with the UE 102 and CN 110. In response to receiving 308 the reconfiguration message, the UE 102 starts 310 QMC and reporting. Depending on the implementation, the UE 102 may begin transmitting 312 uplink (UL) message(s) to the source base station 104, the message(s) containing one or more QoE reports. In some implementations, the uplink message(s) are UL RRC messages. The source base station 104 may then transmit 314 the one or more QoE reports to the Trace Collection Entity (TCE) and/or Multi-cell/Multicast Coordination Entity (MCE) 190. Depending on the implementation, the QoE report(s) may be encapsulated in transparent container(s) that the source base station 104 receives 312 from the UE 102 and forwards to the CN 110 or OAM 180. In further implementations, the UE 102 transmits 312 the QoE report(s) on a periodic basis. In other implementations, the UE 102 transmits 312 the QoE report(s) in response to particular and/or predefined triggering events. The source base station 104 may immediately transmit 314 any received 312 QoE report(s) to the CN 110 or OAM 180. In other implementations, the source base station 104 aggregates the QoE reports before sending a message including the QoE reports to the CN 110 or OAM 180. In yet other implementations, the source base station 104 aggregates the QoE reports with QoE reports from other UE(s) before sending a message including the QoE reports to the CN 110 or OAM 180. The events 302, 304, 306, 307, 308, 310, 312, and 314 are collectively referred to in FIG. 3A as a QMC activation procedure 384.

After the base station 104 receives the “complete” message (not shown) or the UE 102 begins QMC and reporting, the source base station 104 determines 316 to hand over the UE 102 to a target base station 106. In some implementations, the source base station 104 further generates an RRC inter-node message IE (e.g., HandoverPreparationInformation), including the QoE configurations. In further implementations, the RRC inter-node message IE also includes the QoE configuration IDs associated with the QoE configurations. The source base station 104 then transmits 320 a handover request (e.g., HandoverRequest) to the target base station 106. In some implementations, the handover request includes the RRC inter-node message IE. Depending on the implementation, the handover request includes, in addition to the RRC inter-node message IE, one or more of the QoE configurations, the Trace IDs, the Interfaces to Trace IE, the Trace Depth IE, the TCE IP Address (i.e., qoEReference), the UE address (i.e., qoECollectionEntityAddress), the reference IDs, an indication of the QMC activation and/or pause status, and/or the TCE URI as BS-to-BS interface IEs in the handover request. In some implementations, the handover request includes IEs describing area information (i.e., areaScope). In further implementations, the source base station 104 includes the QMC activation command in the handover request in addition to the RRC inter-node message IE. The source base station 104 can additionally include association information indicating the relationship between the QoE configuration IDs and the reference IDs or Trace IDs in the handover request.

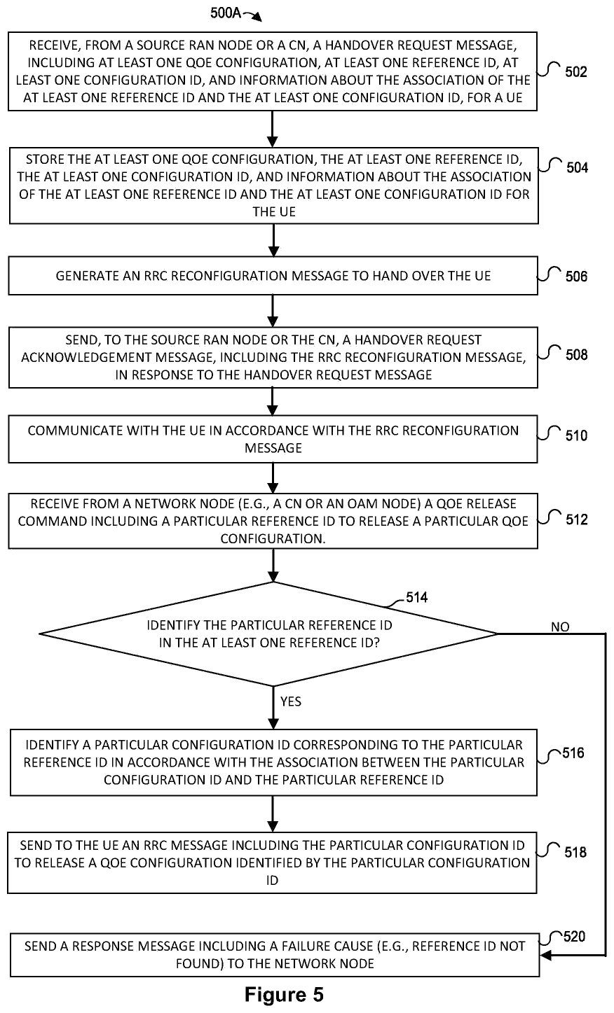

Unlike a base station that manages only a single QoE configuration for a UE, the source base station 104 may transmit multiple QoE configurations, QoE configuration IDs, and reference IDs or Trace IDs, and may further transmit association data or other related data related to multiple QoE configurations. The target base station 106 may then store 337 the QoE configurations as described in regard to FIG. 5.

The target base station 106 then transmits 324 an acknowledgement of the handover request from the source base station 104 and further transmits 324 a radio resource reconfiguration message for the UE 102 to the source base station 104 (e.g., Handover Request Acknowledge). The source base station 104 transmits 326 the radio resource reconfiguration, using an RRC reconfiguration message for example, to the UE 102, which notifies 328 the target base station 106 when reconfiguration is complete. The target base station 106 may then transmit 330 a BS-to-CN message or BS-to-OAM message to the CN 110 or OAM 180, respectively, indicating that the handover has occurred. Depending on the implementation, the source base station 104 or target base station 106 may also transmit a similar message to the CN 110 or OAM 180 at the start of the handover or during the handover, notifying the CN 110 or OAM 180 that a handover is occurring. The events 316, 320, 324, 326, 337, 328, and 330 are collectively referred to in FIG. 3A as a handover procedure 386.

After performing the handover procedure 386, the UE 102 communicates 332 with the target base station 106 and the CN 110. In some implementations, the UE 102 continues or resumes QoE reporting, transmitting 334 UL message(s) to the target base station 106 including one or more QoE reports, similar to event 312 above. The target base station 106 then transmits 336 the one or more QoE reports to the TCE/MCE 190, as described in event 314 above.

The CN 110 or OAM 180 eventually determines to deactivate the QMC and reporting. As such, the CN 110 or OAM 180 transmits 338 a QMC deactivation message to the target base station 106, including a command to release one or more QoE configurations. In some implementations, the target base station 106 may determine 347 whether there is a configuration ID for a stored reference ID as described with regard to FIG. 5. The target base station 106, upon receiving the message, transmits 340 an RRC reconfiguration message to the UE 102, the message including the command to release the one or more indicated QoE configurations. The UE 102 then releases 342 the indicated QoE configurations and stops the QMC and reporting processes. The events 338, 340, and 342 are collectively referred to in FIG. 3A as QMC deactivation procedure 388.

In some implementations with a single Trace ID, the CN 110 or the OAM 180 includes the Trace ID in the QMC deactivation message to command the target base station 106 to release all of the QoE configurations for the UE 102. The target base station 106 can then send 340 the reconfiguration message to the UE 102, commanding the UE 102 to release all of the QoE configurations using the single Trace ID. In further implementations, the CN 110 or the OAM 180 includes a particular reference ID in the QMC deactivation message to indicate that the target base station 106 should release a QoE configuration associated with the reference ID for the UE 102. In such implementations, the target base station 106 can obtain a particular QoE configuration ID in accordance with the particular reference ID and the association information. In yet other implementations, the CN 110 or the OAM 180 includes a particular Trace ID in the QMC deactivation message to indicate that the target base station 106 should release a QoE configuration associated with the Trace ID for the UE 102. In such implementations, the target base station 106 can obtain a particular QoE configuration ID in accordance with the particular Trace ID and the association information.

In some implementations, the QMC deactivation message is a Deactivate Trace message. In other implementations, the QMC deactivation message (e.g., Trace Deactivation IE) is included in an OAM-to-BS message or a CN-to-BS message (e.g., NGAP message). In such implementations, the CN 110 or OAM 180 transmit 338 the message (i.e., the OAM-to-BS message or the CN-to-BS message) including the QMC deactivation message to the target base station 106. In this manner, a QoE configuration for a UE 102 is transferred from a source base station 104 to a target base station 106 and the CN 110 or OAM 180 can deactivate QMC at the target base station.

Referring now to FIG. 3B, a scenario 300B is similar to 300A and similarly involves a CN 110/OAM 180, RAN 105, and UE 102 activating QMC and reporting for the UE 102 before performing a handover. However, unlike scenario 300A, the RAN 105 transmits a command to the UE 102 after the handover to modify the QoE configuration rather than release the QoE configuration.

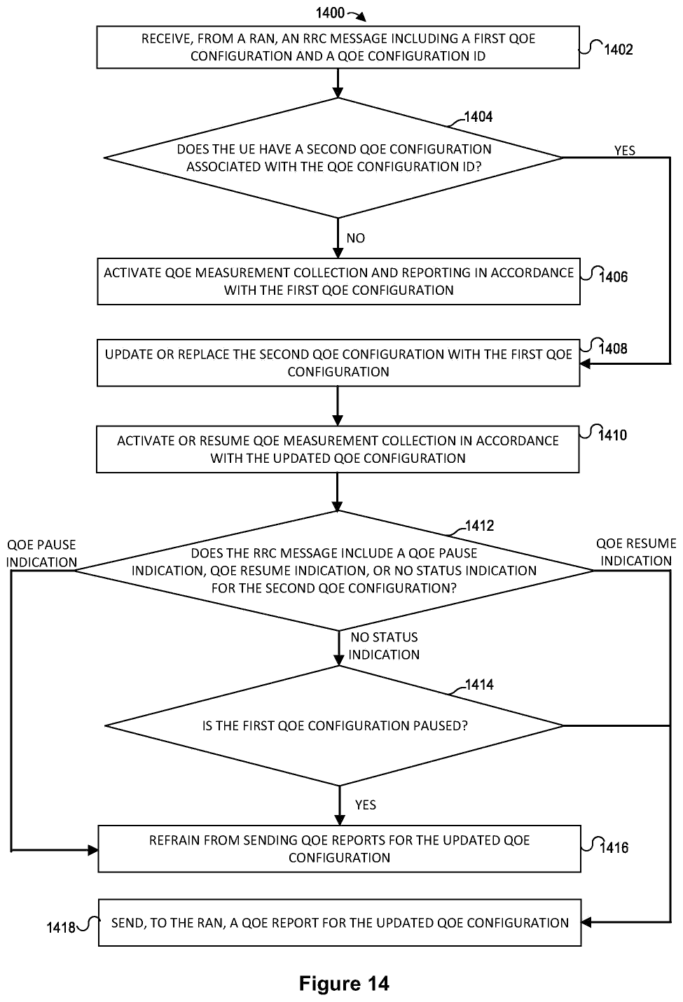

After performing the handover procedure 386 and continuing the QMC and reporting with the UE 102, the CN 110 or OAM 180 transmits 339 a QMC activation message to the target base station 106. The CN 110 or OAM 180 includes a command to modify the one or more QoE configurations in the QMC activation message. The target base station 106 then transmits 341 a radio resource reconfiguration message (e.g., an RRC reconfiguration message) to the UE 102, the message including the command to modify the one or more QoE configurations. Upon receiving 341 the radio resource reconfiguration message, the UE 102 modifies 343 the one or more QoE configurations and begins transmitting 344 uplink RRC messages including QoE reports to the target base station 106 in accordance with the modified QoE configurations. In some implementations, the UE 102 may first determine 345 if a second QoE configuration already exists for a configuration ID before performing a modification, as described below with regard to FIG. 14. The events 339, 341, 343, 344, 345, and 346 are collectively referred to in FIG. 3B as QMC modification procedure 390. Depending on the implementation, the UE 102, target base station 106, and CN 110 or OAM 180 may later perform the QMC deactivation procedure 388 detailed in FIG. 3A above.

Referring next to FIG. 3C, a scenario 300C is similar to 300A and similarly involves a UE 102, source base station 104, and a CN 110/OAM 180 initially performing a QMC activation procedure. However, unlike scenario 300A, during a handover procedure 385, the source base station 104 transmits the QoE configurations to the target base station 106 via the CN 110 or OAM node 180.

After performing the QMC activation procedure 384, the source base station 104, target base station 106, and UE 102 perform a handover procedure 385 that differs from handover procedure 386 as detailed in FIG. 3A above. The source base station 104 transmits 318 a handover required message including the one or more QoE configurations to the CN 110 or OAM 180. The CN 110 or OAM 180 then transmits 319 a handover request message including the one or more QoE configurations to the target base station 106, which in turn stores 337 the QoE configurations and transmits 321 a handover request acknowledge message including a radio resource reconfiguration message to the CN 110 or OAM 180. After receiving 321 the acknowledge message from the BS 106, the CN 110 or OAM 180 transmits 322 a handover command message to the source base station 104 including the radio resource reconfiguration message. The source base station 104 then transmits 326 the radio resource reconfiguration message to the UE 102. The UE 102 transmits 328 a message to the target base station 106 notifying the target base station 106 that the reconfiguration is complete, and the target base station 106 may transmit 330 a BS-to-CN or BS-to-OAM message to the BS 110 or OAM 180, respectively, notifying the CN 110 or OAM 180 that the UE 102 hands over to the target base station 106. The events 318, 319, 321, 322, 326, 337, 328, and 330 are collectively referred to in FIG. 3C as handover procedure 385.

After performing the handover procedure 385, the UE 102 communicates 332 with the target base station 106 and CN 110 as described above. Similarly, the UE 102 may transmit 334 uplink message(s) including QoE reports to the target base station 106, which may transmit 336 the QoE report(s) to the CN 110 or OAM 180 as described above. Depending on the implementation, the US 102, target base station 106, and CN 110 or OAM 180 may then perform either or both of the QMC modification procedure 390 and QMC release procedure 388 as described in FIGS. 3A and 3B.

Referring next to FIG. 3D, in a scenario 300D the RAN 105 pauses QoE reporting at a source base station 104 before performing a handover procedure and resumes the QoE reporting at a target base station 106 after performing the handover procedure.

After performing the QMC activation procedure 384, the CN 110 or OAM 180 determines 348 to pause the QoE reporting. In some implementations, the CN 110 or OAM 180 makes the determination 348 in response to a request by the UE 102 via the source base station 104 or in response to a request by the source base station 104. The UE 102 may send the request to the CN 110 or OAM 180 via the source base station 104 in response to determining to save power or in response to pausing an application to which the QoE reporting is associated. In further implementations, the source base station 104 may send the request to the CN 110 or OAM 180 in response to receiving more than a pre-determined amount of information from one or more UEs (i.e., RAN overload). After making the determination 348, the CN 110 or OAM 180 transmits 350 a command to the source base station 104 to pause QoE reporting (e.g., a QoE pause command). After receiving 350 the command, the source base station 104 transmits 352 the command to pause QoE reporting to the UE 102. The UE 102 then pauses 354 the QoE reporting. The events 348, 350, 352, and 354 are collectively referred to in FIG. 3D as QoE pause procedure 392.

After performing the QoE pause procedure 392, the UE 102, source base station 104, and CN 110 or OAM 180 perform a handover procedure 385/386 with target base station 106, as described in FIGS. 3A and 3C. In some implementations, the source base station 104 transmits a pause status indication associated with the QoE configuration during the handover procedure 385/386. In implementations in which the source base station 104 communicates directly with the target base station 106 (i.e., handover procedure 386), the source base station 104 can include the QoE pause status indication in the handover request message to the target base station 106. In implementations in which the source base station 104 communicates with the target base station 106 via the CN 110 or OAM 180 (i.e., handover procedure 385), the source base station 104 can include the QoE pause status indication in the handover required message to the CN 110 or OAM 180. The CN 110 or OAM 180 then includes the QoE pause status indication in the handover request message to the target base station 106. As such, the target base station 106 determines that the UE 102 has paused QoE reporting for the QoE configuration based on the QoE pause status indication.

After performing the handover procedure 385/386, the CN 110 or OAM 180 determines 355 to resume the QoE reporting and transmits 356 a QoE resume command to the target base station 106 to resume the QoE reporting. In response to receiving 356 the command, the target base station 106 transmits 358 the QoE resume command on to the UE 102, which subsequently resumes 360 QoE reporting and begins transmitting 334 uplink messages including QoE reports to the target base station 106, which in turn transmits 336 QoE reports to the TCE/MCE 190. The events 360, 334, and 336 are collectively known in FIG. 3D as QoE reporting resumption procedure 394. Events 355, 356, 358, and 394 are collectively known in FIG. 3D as QoE reporting resume procedure 396.

Referring next to FIG. 3E, scenario 300E is similar to 300D and similarly includes a UE 102 pausing and resuming QoE reporting. However, unlike scenario 300D, a source base station 104 determines to pause the QoE reporting and a target base station 106 determines to release the QoE reporting rather than a CN 110 or OAM node 180 making these determinations.

After performing the QMC activation procedure 384, the source base station 104 determines 349 to pause the QoE reporting. In some implementations, the source base station 104 may make the determination 349 after receiving a request from the UE 102. The UE 102 may send the request to the source base station 104 in response to determining to save power. In further implementations, the source base station 104 may make the determination 349 in response to receiving more than a pre-determined amount of information from one or more UEs (i.e., RAN overload). In response to determining 349 to pause the QoE reporting, the source base station 104 transmits 352 a QoE pause command to the UE 102 to pause the QoE reporting (e.g., an RRCConnectionReconfiguration message or RRCReconfiguration message). In some implementations, the command includes a measConfigAppLayer information element including a QoE pause command to temporarily pause the QoE reporting. In such implementations, the UE 102 may continue to perform QMC and only stop the reporting. After receiving the command, the UE 102 pauses 354 the QoE reporting. The events 349, 352, and 354 are collectively known in FIG. 3E as QoE pause procedure 391.

Unlike systems that use pausing only to address RAN overload, the RAN 105 uses pausing of the QoE reporting at one node and resuming the QoE reporting at another after or while performing a handover.

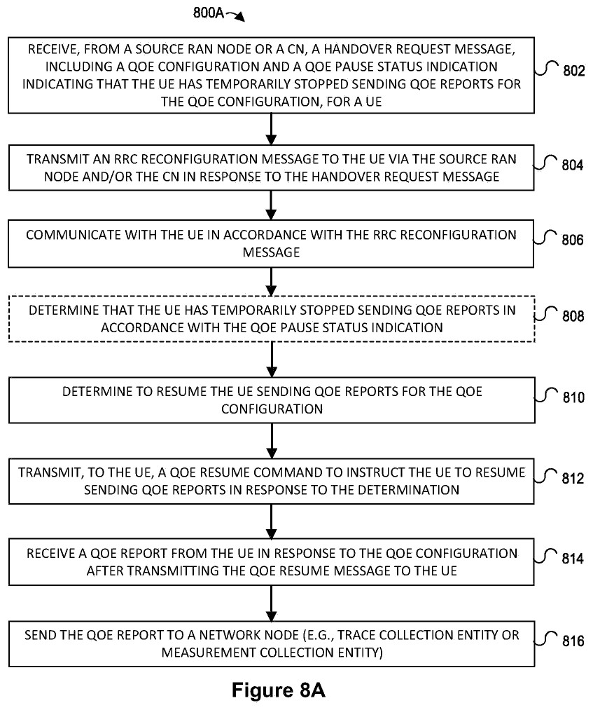

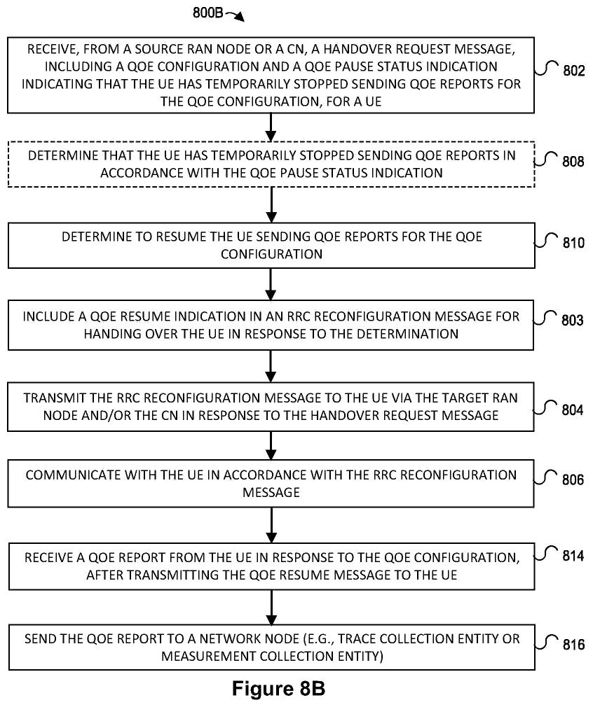

After performing QoE pause procedure 391, the UE 102, source base station 104, and CN 110 or OAM 180 perform a handover procedure 385/386 with target base station 106 as described in FIGS. 3A and 3C above. In some implementations, the UE 102 and/or the CN 110 or OAM 180 receives an indication that the QoE reporting is paused. After or in response to the handover procedure 385/386, the target base station 106 determines 357 to resume the QoE reporting and transmits 358 a QoE resume command to the UE 102 to resume QoE reporting. In some implementations, the target base station 106 first determines 367 whether the QoE reporting is paused, as described in more detail below with regard to FIGS. 8A-8B. The UE 102, source base station 104, and TCE/MCE 190 then perform a QoE reporting resumption procedure 394 as described above.

Referring next to FIG. 3F, scenario 300F is a scenario similar to 300E and similarly involves performing a QoE reporting pause procedure and a subsequent handover procedure for the UE 102. However, in scenario 300F the preparation for the handover rather than a determination by the RAN 105 or CN 110/OAM node 180 triggers the resume process and causes the source base station 104 to determine to transmit a QoE resume command.

After performing the QoE pause procedure 391, the source base station 104 determines 316 to hand over the UE 102. In response to the determination 316, the source base station 104 transmits 317 a QoE resume command to the UE 102 to resume QoE reporting. The UE 102 then resumes 360 QoE reporting in response to receiving 317 the command. After resuming 360 the QoE reporting and performing the handover procedure 385/386, the UE 102 may begin transmitting 334 uplink message(s) including QoE report(s) to the target base station 106, which transmits the QoE report(s) 336 to the TCE/MCE 190.

Referring next to FIG. 3G, scenario 300G is similar to 300D and similarly involves a base station and a UE 102 pausing QoE reporting. However, the target base station 106 determines to resume the QoE reporting during the handover procedure and transmits an indication to resume to the source base station 104 in response.

After performing the QoE pause procedure 391, the source base station 104 determines 316 to hand over the UE 102. The source base station 104 then transmits 320 a handover message including one or more QoE configurations to the target base station 106. In response to receiving 320 the handover message, the target base station 106 determines 357 to resume the QoE reporting. In some implementations, the target base station 106 makes the determination 357 in response to receiving the QoE configuration(s) in the handover request. In further implementations, the source base station 104 includes an indication that the QoE reporting has been paused in the handover request message, and the target base station 106 makes the determination 357 in response to receiving the indication. In some implementations, the target base station 106 first determines 367 whether the QoE reporting is paused, as described in more detail below with regard to FIGS. 8A-8B.

After making the determination 357 to resume QoE measurement reporting, the target base station 106 transmits 323 a handover request acknowledge message to the source base station 104, the handover message including at least an RRC reconfiguration message and a command to resume QoE reporting (e.g., QoE resume indication). The source base station 104 then transmits 325 the radio resource reconfiguration message and the command to resume QoE reporting to the UE 102, which in turn resumes 360 QoE reporting before transmitting 328 a notification that RRC reconfiguration is complete to the target base station 106. In some implementations, the UE 102 retains 376 QoE configuration(s) and releases a pause status before resuming QoE measurement reporting, as described below with regard to FIG. 11B. In some implementations, the RRC reconfiguration message does not include a QoE resume indication and the UE 102 determines 377 whether the UE 102 received a resume indication before resuming 360, as described in more detail with regard to FIG. 11A below. The target base station 106 then transmits 330 a BS-to-CN message or BS-to-OAM message to the CN 110 or OAM 180, respectively, to notify the CN 110 or OAM 180 that a handover has taken place. The UE 102 then communicates 332 with the target base station 106 and CN 110 and transmits 334 uplink message(s) including QoE report(s) to the target base station 106, which transmits 336 the QoE report(s) to the TCE/MCE 190.

Referring next to FIG. 3H, scenario 300H is similar to 300G and similarly involves the source base station 104 and the UE 102 performing a QoE reporting pause procedure. However, a CN 110 or OAM node 180 handles the handover for the RAN 105.

After performing the QoE pause procedure 391, the source base station 104 transmits 318 a handover required message including one or more QoE configurations to the CN 110 or OAM 180, which subsequently transmits a handover request message including the one or more QoE configurations to the target base station 106, as described in FIG. 3C. In response to receiving 319 the handover request message, the target base station 106 determines 357 to resume the QoE reporting as described above. In some implementations, the target base station 106 determines 367 whether QoE reporting is paused as described with regard to FIG. 8A-8B below. The target base station 106 then transmits 327 an RRC reconfiguration message including an indication (or command) to resume QoE reporting in a handover request acknowledge message to the CN 110 or OAM 180. The CN 110 or OAM 180 then forwards 329 the RRC reconfiguration message including the indication to resume QoE reporting in a handover command message to the source base station 104, which in turn transmits 325 the RRC reconfiguration message and QoE reporting resume indication (or command) to the UE 102. In response, the UE 102 resumes 360 the QoE measurement reporting. In some implementations, the UE 102 may first determine 377 whether the UE 102 received a resume or pause status indication or may retain 376 QoE configurations and release a pause status of the UE 102 as described below with regard to FIGS. 11A and 11B, respectively.

Referring next to FIG. 3I, scenario 300I is similar to 300D and similarly includes a CN 110 or OAM node 180 determining to pause QoE reporting. However, the CN 110 or OAM node 180 attempts to transmit a pause command to the source node 104 but receives an indication that QoE pausing has failed and subsequently transmits a QoE pause command to the target base station 106.

After performing the QMC activation procedure 384, the CN 110 or OAM 180 determines 348 to pause the QoE reporting at the UE 102 and transmits 350 a QoE pause command to the source base station 104 to pause the QoE reporting. However, the source base station 104 transmits 358 a failure indication to the CN 110 or OAM 180 in response. In some implementations, the failure is due to handover occurring or having occurred. In other implementations, the failure is due to the source base station 104 determining to perform a handover procedure 385/386. In still other implementations, the source base station 104 determines that the RAN 105 cannot transmit the command to the UE 102 and determines to perform a handover procedure 385/386 subsequent to receiving 350 the command to pause the QoE reporting.

The source base station 104, the UE 102, and the CN 110 or OAM 180 perform a handover procedure 385/386 with the target base station 106. After the handover procedure 385/386 completes, the CN 110 or OAM 180 transmits 362 the command to pause QoE reporting to the target base station 106. The target base station 106 then transmits 364 the command to the UE 102, which then pauses 354 QoE reporting.

In some scenarios or implementations, the source base station 104 may determine to hand over the UE 102 to the target base station 106 during the QMC activation or deactivation procedure. In such cases, the base station 104 sends a QoE failure indication to the CN 110 or OAM 180 in response to the QMC activation or deactivation command in the QMC activation or deactivation procedure. After the handover procedure 385/386 completes or after receiving from the target base station 106 an indication that the UE has connected to the target base station 106 (similar to event 330), the CN 110 or OAM 180 can continue the QMC activation or deactivation procedure by transmitting the QMC activation or deactivation command to the target base station 106. The target base station 106 then transmits the command to the UE 102.

Referring next to FIG. 3J, scenario 300J is similar to 300D and similarly includes a CN 110 or OAM node 180 performing a QoE reporting pause procedure and subsequently determining to resume the QoE reporting. However, the CN 110 or OAM node 180 attempts to transmit a resume command to the source node but receives an indication that QoE resumption has failed and subsequently transmits a QoE resume command to the target base station 106.

After performing the QoE pause procedure 392, the CN 110 or OAM 180 determines 366 to resume the QoE reporting and transmits 368 a QoE resume command to the source base station 104 to resume QoE reporting. However, the source base station 104 transmits 358 a QoE failure indication to the CN 110 or OAM 180 in response. In some implementations, the failure is due to handover occurring or having occurred. In other implementations, the failure is due to the source base station 104 determining to perform a handover procedure 385/386. In still other implementations, the source base station 104 determines that the RAN 105 cannot transmit the command to the UE 102 and determines to perform a handover procedure 385/386 after receiving 368 the command to resume the QoE reporting.

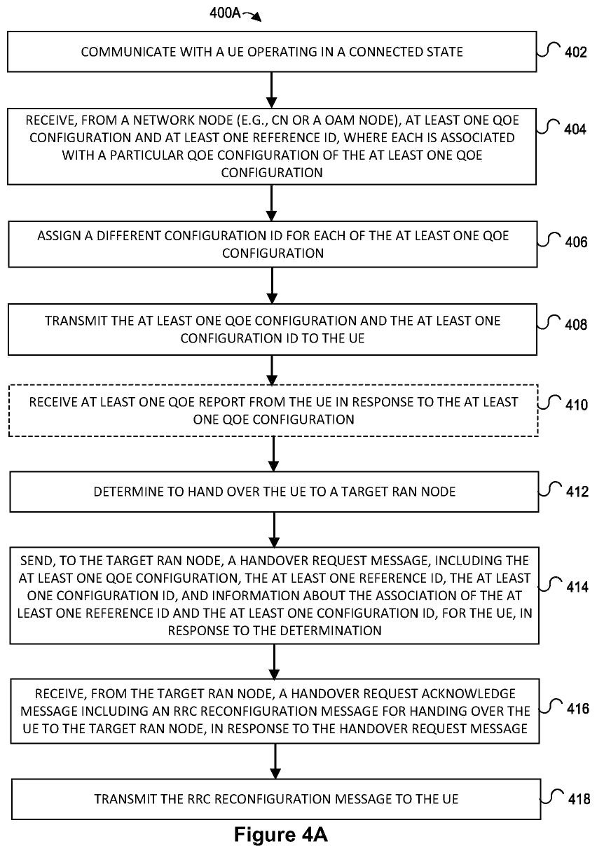

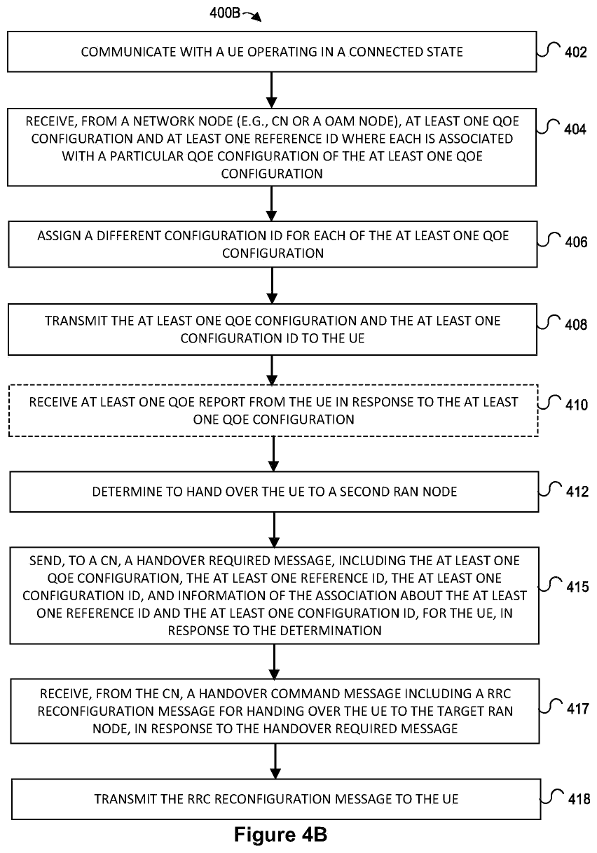

Next, several example methods that can be implemented in a UE, a RAN, a CN, or an OAM node are discussed with reference to FIGS. 4A-19. Each of these methods can be implemented using processing hardware such as one or more processors to execute instructions stored on a non-transitory computer-readable medium such as computer memory.

Referring first to FIG. 4A, a method 400A can be implemented in a source node of a suitable RAN, and includes transmitting one or more QoE configurations, reference identifiers, configuration identifiers, and information on the association between reference identifiers and configuration identifiers to a target node in a handover message. For clarity, the method 400A is discussed with specific reference to the RAN 105, the source base station 104 as a source node, the target base station 106 as a target node, the CN 110 or OAM 180 as a QoE node (e.g., a network node), and the UE 102.

At block 402, the source base station 104 communicates with a UE 102 operating in a connected state (e.g., events 304 and 384 of FIGS. 3A-3C). At block 404, the source base station 104 receives at least one QoE configuration and at least one reference ID from the CN 110 or OAM 180 (e.g., events 306 and 384 of FIGS. 3A-3C). In some implementations, each of the reference IDs are associated with a particular QoE configuration. At block 406, the source base station 104 assigns a different configuration ID to each QoE configuration (e.g., event 307 or 384 of FIGS. 3A-3C). Then, at block 408, the source base station 104 transmits each QoE configuration and each configuration ID to the UE 102 (e.g., events 308 and 384 of FIGS. 3A-3C). In some implementations, the flow continues to block 410, where the source base station 104 receives at least one QoE report from the UE 102 after transmitting the QoE configurations (e.g., events 312 and 384 of FIGS. 3A-3C).

At block 412, the source base station 104 determines to perform a handover of the UE 102 to the target base station 106 (e.g., events 316 or 386/385 of FIGS. 3A-3C). Then, at block 414, the source base station 104 transmits a handover request message for the UE 102 to target base station 106 (e.g., events 320 or 386 of FIGS. 3A-3B). In some implementations, the handover request message includes at least the QoE configuration(s), the reference ID(s), the configuration ID(s), and information on the association between the reference ID(s) and the configuration ID(s). At block 416, the source base station 104 then receives a handover request acknowledge message from the target base station 106 (e.g., events 324 or 386 of FIGS. 3A-3B). The handover request acknowledge message includes an RRC reconfiguration message for handing over the UE 102 to the target base station 106. The source base station 104 then, at block 418, transmits the RRC reconfiguration message to the UE 102 (e.g., events 326 or 386 of FIGS. 3A-3B).

Referring next to FIG. 4B, a method 400B is generally similar to the method 400A, but here the source base station 104 transmits data to a CN 110 or OAM node 180 to perform the handover operation. More specifically, the differences between the methods of FIG. 4A and FIG. 4B are discussed below.

After the source base station 104 determines to handover the UE 102 to a target node, such as target base station 106 of the RAN 105, at block 412, the flow continues to block 415. At block 415, the source base station 104 transmits a handover required message for the UE 102 to a CN 110 (e.g., event 318 of FIG. 3C). In some implementations the handover required message includes at least the QoE configuration(s), the reference ID(s), the configuration ID(s), and information on the associate between the reference ID(s) and the configuration ID(s). At block 417, the source base station 104 then receives a handover command message from the CN 110 (e.g., event 322 of FIG. 3C). The handover command message includes an RRC reconfiguration message for handing over the UE 102 to the target base station 106. Thus FIG. 4B applies to the signaling described in FIG. 3C.

Referring now to FIG. 5, a method 500 can be implemented in a target node of a suitable RAN, and includes transmitting QoE configurations and associated identifiers and further determining whether to release a QoE configuration based on whether previously received identifiers included a particular reference identifier. For clarity, the method 500 is discussed with specific reference to the RAN 105, the source base station 104 as a source node, the target base station 106 as a target node, the CN 110 or OAM 180 as a QoE node, and the UE 102.

At block 502, a target base station 106 receives a handover request message for a UE 102 from a source base station 104 or from a CN 110 (e.g., events 320/386 or 319/385 of FIGS. 3A-C). The handover request message includes at least QoE configuration(s), reference ID(s), configuration ID(s), and information on the association between the reference ID(s) and the configuration ID(s). At block 504, the target base station 106 then stores the QoE configuration(s), the reference ID(s), the configuration ID(s), and the information on the association between the reference ID(s) and the configuration ID(s) (e.g., event 337 of FIGS. 3A-3C).

At block 506, the target base station 106 generates an RRC reconfiguration message for handing over the UE 102. At block 508, the target base station 106 then transmits a handover request acknowledgement message including the RRC reconfiguration message to the source base station 104 or the CN 110 (e.g., events 324/386 or 321/385 of FIGS. 3A-3C). The target base station 106 then communicates with the UE 102 in accordance with the RRC reconfiguration message at block 510 (e.g., event 332 of FIGS. 3A-3C). At block 512, the target base station 106 receives a QoE release command from the CN 110 or an OAM node 180 (e.g., events 338/388 of FIGS. 3A-3C). The QoE release command includes a particular reference ID to release a particular QoE configuration.

At block 514, the target base station 106 determines whether the stored reference IDs include the particular reference ID (e.g., events 347 or 388 of FIGS. 3A-3C). If the target base station 106 does not identify the particular reference ID in the stored reference IDs, then the flow continues to block 520 where the target base station 106 transmits a response to the CN 110 or OAM 180 indicating that the release failed. In some implementations, the response includes a failure cause, such as indicating that the RAN 105 did not find the reference ID. In other implementations, the RAN 105 at block 520 alternatively ignores the request to release a particular QoE configuration and can subsequently transmit a response message without a failure cause. If the target base station 106 does identify the particular reference ID in the stored reference IDs, the flow proceeds to block 516. At block 516, the target base station 106 identifies a particular QoE configuration ID corresponding with the particular reference ID in accordance with the information on the association between the particular QoE configuration ID and the particular reference ID (e.g., events 347/388 of FIGS. 3A-3C). At block 518, the target base station 106 then transmits an RRC message including the particular QoE configuration ID to release the QoE configuration identified by the particular QoE configuration ID (e.g., events 340/388 of FIGS. 3A-3C).

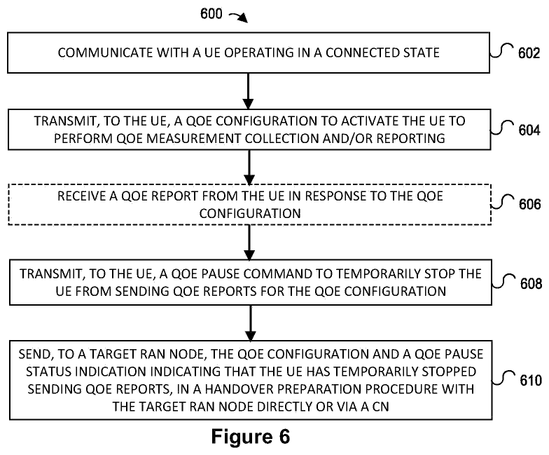

Referring now to FIG. 6, a method 600 can be implemented in a source node of a suitable RAN and includes transmitting a QoE pause command to a UE and a pause status indication to a target node. For clarity, the method 600 is discussed with specific reference to the RAN 105, the source base station 104 as a source node, the target base station 106 as a target node, the CN 110 or OAM 180 as a QoE node, and the UE 102.

At block 602, a source node of the RAN 105, such as source base station 104, communicates with a UE 102 operating in a connected state (e.g., event 304 within event 384 of FIGS. 3D-3J). At block 604, the source base station 104 transmits a QoE configuration to the UE 102 to activate QMC and reporting for the UE 102 (e.g., event 308 within event 384 of FIGS. 3D-3J). In some implementations, the flow then continues to block 606, where the source base station 104 receives QoE report(s) from the UE 102 (e.g., event 312 within event 384 of FIGS. 3D-3J). At block 608, the source base station 104 transmits a QoE pause command to the UE 102 to temporarily stop the UE 102 from transmitting QoE reports in accordance with the QoE configuration (e.g., events 350/392 or 352/391 of FIGS. 3D-3J). At block 610, the source base station 104 transmits to a target node of the RAN 105, such as target base station 106, the QoE configuration and an indication of the QoE pause status in a handover preparation procedure (e.g., events 319, 320, or 385/386 of FIGS. 3D-3J). In some implementations, the source base station 104 transmits to target base station 106 directly. In other implementations, the source base station 104 transmits to target base station 106 by way of the CN 110. In this manner, the QoE measurement reporting pause is implemented through the source base station 104 and indicated to the target base station 106.

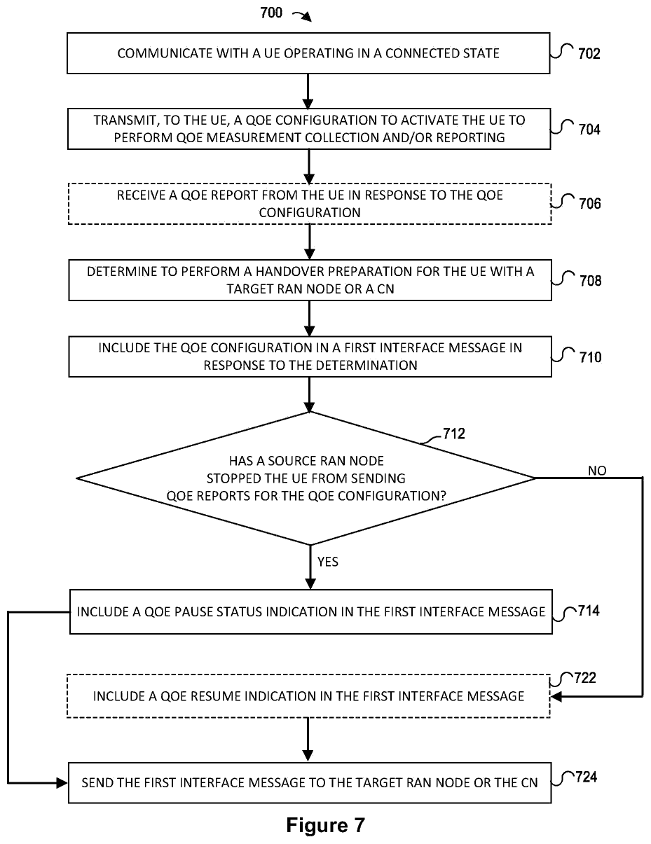

Referring now to FIG. 7, a method 700 can be implemented in a source node of a suitable RAN and includes performing a handover for a UE and determining whether to include a QoE pause status indication or a QoE resume indication in a handover message. For clarity, the method 700 is discussed with specific reference to the RAN 105, the source base station 104 as a source node, the target base station 106 as a target node, the CN 110 or OAM 180 as a QoE node, and the UE 102.

At block 702, a source base station 104 communicates with a UE 102 operating in a connected state (e.g., event 304 within event 384 of FIGS. 3D-3J). At block 704, the source base station 104 transmits a QoE configuration to the UE 102 to activate QMC and reporting at the UE 102 (e.g., event 308 within event 384 of FIGS. 3D-3J). In some implementations, the flow continues to block 706, where the source base station 104 receives QoE report(s) from the UE 102 (e.g., event 312 within event 384 of FIGS. 3D-3J). At block 708, the source base station 104 determines to perform a handover preparation for the UE 102 with a target base station 106, or a CN 110 (e.g., events 316 or 385/386 or FIGS. 3D-3J). At block 710, the source base station 104 then transmits a first interface message including the QoE configuration (e.g., events 318/385 or 320/386 of FIGS. 3D-3J).

At block 712, the source base station 104 determines whether the UE 102 has stopped the UE 102 from transmitting QoE reports in accordance with the QoE configuration. If the UE 102 has stopped transmitting QoE reports, then flow continues to block 714, where the source base station 104 includes a QoE pause status indication in the first interface message (e.g., events 318/385 or 320/386 of FIGS. 3D-3E, 3G-3H, 3J). In some implementations, if the UE 102 has not stopped transmitting QoE reports, then the source base station 104 includes a QoE resume indication in the first interface message (e.g., events 318/385 or 320/386 of FIG. 3F). After block 714, 712, or 722, the flow then continues to block 724, where the source base station 104 transmits the first interface message to the target base station 106 or the CN 110 (e.g., events 318/385 or 320/386 of FIGS. 3D-3J).

Referring now to FIG. 8A, a method 800A can be implemented in a target node of a suitable RAN and includes determining to and subsequently transmitting a command to the UE to resume QoE reporting after performing a handover. For clarity, the method 800A is discussed with specific reference to the RAN 105, the source base station 104 as a source node, the target base station 106 as a target node, the CN 110, the TCE/MCE 190 as a QoE node, and the UE 102.

At block 802, a target base station 106 receives a handover request message from a source base station 104 or a CN 110 (e.g., events 320 or 386 of FIGS. 3D-3G and 3I-3J). The handover request message includes a QoE configuration and a QoE pause status indication that indicates that the UE 102 has temporarily paused QoE reporting. At block 804, the target base station 106 transmits an RRC reconfiguration message to the UE 102 via the source base station 104 or via the CN 110 (e.g., events 323/325/386 or 327/329/325/385 of FIGS. 3D-3J). Then, at block 806, the target base station 106 communicates with the UE 102 in accordance with the RRC reconfiguration message (e.g., event 332 of FIGS. 3E-3J). In some implementations, the flow continues to block 808, where the target base station 106 determines that the UE 102 has temporarily paused QoE reporting in accordance with the QoE pause status indication (e.g., event 367 of FIGS. 3E, 3G, and 3H).

At block 810, the target base station 106 determines to resume QoE reporting at the UE 102 (e.g., event 357 of FIGS. 3E, 3G, and 3H). In some implementations, the target base station 106 makes the determination in response to calculating that a predetermined period of time has passed since the last pause status indication. In other implementations, the target base station 106 makes the determination based on an indication from the UE 102, source base station 104, or CN 110. In yet other implementations, the target base station 106 makes the determination in response to observing that the target base station 106 is not busy. At block 812, the target base station 106 transmits a QoE resume command to the UE 102 to instruct the UE 102 to resume QoE reporting (e.g., event 358 of FIG. 3E). Then, at block 814, the target base station 106 receives a QoE report from the UE 102 (e.g., events 394 or 334 of FIGS. 3E, 3G, and 3H) and transmits, at block 816, the QoE report to a TCE or MCE 190 (e.g., events 394 or 336 of FIGS. 3E, 3G, and 3H).

Referring now to FIG. 8B, a method 800B is generally similar to the method 800A, but here the target base station 106 transmits a QoE resume indication to the UE 102 in a handover message. More specifically, the differences between the methods of FIG. 8A and FIG. 8B are discussed below.

In method 800B, the flow proceeds from block 802 to block 808 and block 810. After the target base station 106 determines to resume the QoE reporting at block 810, the flow continues to block 803. At block 803, the target base station 106 includes a QoE resume indication in a radio resource reconfiguration message for handing over the UE 102 (e.g., event 325 of FIGS. 3G and 3H). The flow then continues to blocks 804, 806, 814, and 816, as described above.

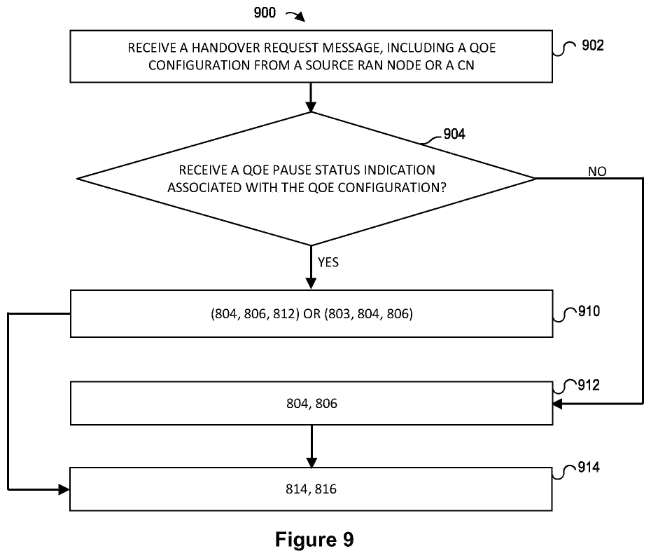

Referring now to FIG. 9, a method 900 can be implemented in a target node of a suitable RAN and includes determining whether to resume QoE reporting based on whether the base station receives a QoE pause status indication associated with the QoE configuration. For clarity, the method 900 is discussed with specific reference to the RAN 105, the source base station 104 as a source node, the target base station 106 as a target node, the CN 110 or OAM 180 as a QoE node, and the UE 102.

At block 902, a target base station 106 receives a handover request message including a QoE configuration from a source base station 104 or a CN 110 (e.g., events 320/386 or 319/385 of FIGS. 3D-3J). At block 904, the target base station 106 determines whether the target base station 106 received a QoE pause status indication associated with the QoE configuration in the handover request message. If the target base station 106 did receive a QoE pause status indication, then the flow continues to block 910. At block 910, the target base station 106 either (i) transmits an RRC reconfiguration message to the UE 102, communicates with the UE 102 in accordance with the RRC reconfiguration message, and transmits a QoE reporting resume command to the UE 102 as described in blocks 804, 806, and 812 respectively of FIG. 8A (e.g., events 323/325/386 or 327/329/325/385 of FIGS. 3D-3J; event 332 of FIGS. 3D-3J; and event 358 of FIG. 3E); or (ii) the target base station 106 includes a QoE reporting resume indication in a radio resource reconfiguration message, transmits the RRC reconfiguration message to the UE 102, and communicates with the UE 102 in accordance with the RRC reconfiguration message as described in blocks 803, 804, and 806, respectively, of FIG. 8B (e.g., event 325 of FIGS. 3G and 3H; events 323/325/386 or 327/329/325/385 of FIGS. 3D-3J; and event 332 of FIGS. 3D-3J).

If the target base station 106 did not receive a QoE pause status indication, then the flow continues to block 912. At block 912, the target base station 106 transmits an RRC reconfiguration message to the UE 102 and communicates with the UE 102 in accordance with the RRC reconfiguration message, as described in blocks 804 and 806 above (e.g., events 323/325/386 or 327/329/325/385 of FIGS. 3D-3J and event 332 of FIGS. 3D-3J). The RRC reconfiguration message does not include a QoE reporting resume indication. Both of blocks 910 and 912 then continue to block 914, where the target base station 106 receives a QoE report from the UE and transmits the QoE report to a QoE node, as described in blocks 814 and 816, respectively (e.g., events 394 or 334 of FIGS. 3E, 3G, and 3H; and events 394 or 336 of FIGS. 3E, 3G, and 3H).

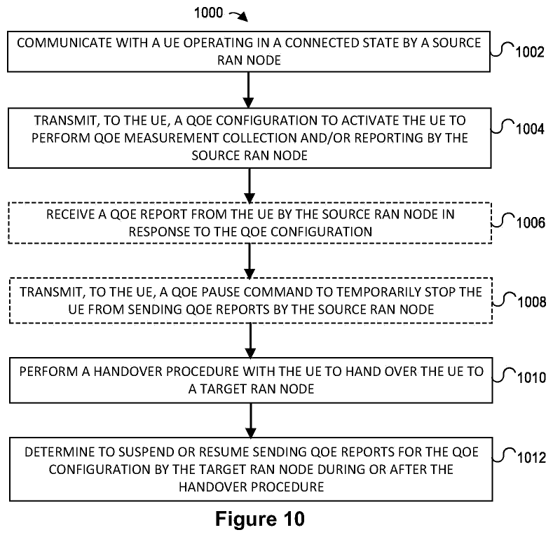

Referring now to FIG. 10, a method 1000 can be implemented in a suitable RAN and includes determining whether to pause or resume QoE reporting in accordance with a QoE configuration after performing a handover procedure. For clarity, the method 1000 is discussed with specific reference to the RAN 105, the source base station 104 as a source node, the target base station 106 as a target node, the CN 110 or OAM 180 as a QoE node, and the UE 102.

At block 1002, the RAN 105 communicates with a UE 102 operating in a connected state via a source base station 104 (e.g., event 384 of FIGS. 3D-3J). At block 1004, the RAN 105 transmits a QoE configuration to the UE 102 to activate QMC and reporting via the source base station 104 (e.g., event 384 of FIGS. 3D-3J). In some implementations, the flow continues to blocks 1006 and/or 1008. At block 1006, the RAN 105 receives a QoE report from the UE 102 via the source base station 104 (e.g., event 384 of FIGS. 3D-3J). At block 1008, the RAN 105 transmits a QoE pause command to the UE 102 via the source base station 104 to temporarily pause QoE reporting (e.g., events 352 or 391/392 of FIGS. 3D-3J). Then, at block 1010, the RAN 105 performs a handover procedure with the UE 102 to handover the UE 102 from the source base station 104 to a target base station 106 (e.g., events 385 or 386 of FIGS. 3D-3F and 3I-3J; events 316/320/323/325 of FIG. 3G; or events 318/319/327/329/325 of FIG. 3H).

At block 1012, the RAN 105 determines to pause or resume QoE reporting for the QoE configuration via the target base station 106 (e.g., event 357 of FIGS. 3E, 3G, and 3H or event 349/391 of FIGS. 3E-3H). In some alternative implementations, the flow may proceed from block 1008 directly to block 1012 and proceed to block 1010 after block 1012. As such, depending on the implementation, the RAN 105 may determine to pause or resume the QoE reporting before, during, or after performing the handover. For example, in some implementations, the RAN 105 makes the determination at block 1012 in response to determining to perform the handover or receiving an indication to perform the handover. As such, the RAN 105 pauses or resumes the QoE reporting as part of the handover. In other implementations, the RAN 105 makes the determination in response to beginning or performing a particular step of the handover process, such as making the determination in response to receiving an acknowledgement of the handover request from the target base station 106. In further implementations, the RAN 105 makes the determination in response to completing the handover or receiving a notification from the UE 102 that handover is complete.

Referring now to FIG. 11A, a method 1100A can be implemented in a suitable UE and includes for receiving a command to pause QoE reporting and subsequently determining whether to resume QoE reporting based on whether the UE receives a QoE resume indication or a QoE configuration. For clarity, the method 1100A is discussed with specific reference to the RAN 105 and the UE 102.

At block 1102, the UE 102 communicates with a RAN 105 via a first cell while operating in a connected state (e.g., event 384 of FIGS. 3D-3J). At block 1104, the UE 102 receives a QoE configuration from the RAN 105 (e.g., event 384 of FIGS. 3D-3J). The QoE configuration activates QMC and reporting for the UE 102. Then, at block 1106, the UE 102 performs QMC in accordance with the QoE configuration (e.g., event 384 of FIGS. 3D-3J). In some implementations, the flow continues to block 1108, where the UE 102 transmits a QoE report to the RAN 105 in accordance with the QoE configuration (e.g., event 384 of FIGS. 3D-3J). At block 1110, the UE 102 receives a QoE pause command from the RAN 105, temporarily pausing QoE reporting for the QoE configuration at the UE 102 (e.g., events 352, 391/392, or 364 of FIGS. 3D-3J). In response, the UE 102 pauses QoE reporting for the QoE configuration at block 1112 (e.g., events 354 or 391/392 of FIGS. 3D-3J).

At block 1114, the UE 102 receives a downlink message from the RAN 105, causing the UE 102 to perform a handover to a second cell (e.g., events 385/386 of FIGS. 3D-3F and 3I-3J or event 325 of FIGS. 3G-3H). At block 1116, the UE 102 retains the QoE configuration and the QoE pause status through the handover. At block 1118, the UE 102 performs the handover to the second cell in accordance with the downlink message from the RAN 105 (e.g., events 385/386 of FIGS. 3D-3F and 3I-3J or events 325/360/328 of FIGS. 3G-3H). At block 1120, the UE 102 determines whether the UE 102 receives either of a resume indication for the QoE configuration or the QoE configuration in the downlink message (e.g., event 377 of FIGS. 3G-3H). If the UE 102 determines that the UE 102 does receive a resume indication or the QoE configuration, then the flow continues to block 1122. At block 1122, the UE 102 resumes QoE reporting and transmitting QoE reports for the QoE configuration (e.g., events 360 or 394/396 of FIGS. 3D-3J). If the UE 102 determines that the UE 102 does not receive a resume indication or the QoE configuration, then the flow continues to block 1124. At block 1124, the UE 102 continues to keep the reporting for the QoE configuration paused.

Referring now to FIG. 11B, a method 1100B is generally similar to the method 1100A, but here the UE 102 resumes QoE reporting in response to performing a handover and without receiving a QoE resume indication. More specifically, the differences between the methods of FIG. 11A and FIG. 11B are discussed below.

In method 1100B, after the UE 102 receives a downlink message from the RAN 105, the flow continues to block 1117. At block 1117, the UE 102 retains the QoE configuration and releases the QoE pause status (e.g., event 376 of FIGS. 3G-3H). The flow then continues to block 1118, as described above, and block 1123. At block 1123, the UE 102 resumes QoE reporting at the UE 102 without receiving a QoE resume indication in the downlink message (e.g., event 325 of FIGS. 3G-3H). In some implementations, the UE 102 resumes QoE reporting in response to performing or determining to perform the handover. In other implementations, the UE 102 may resume the QoE reporting in response to a timer or predetermined time period elapsing.

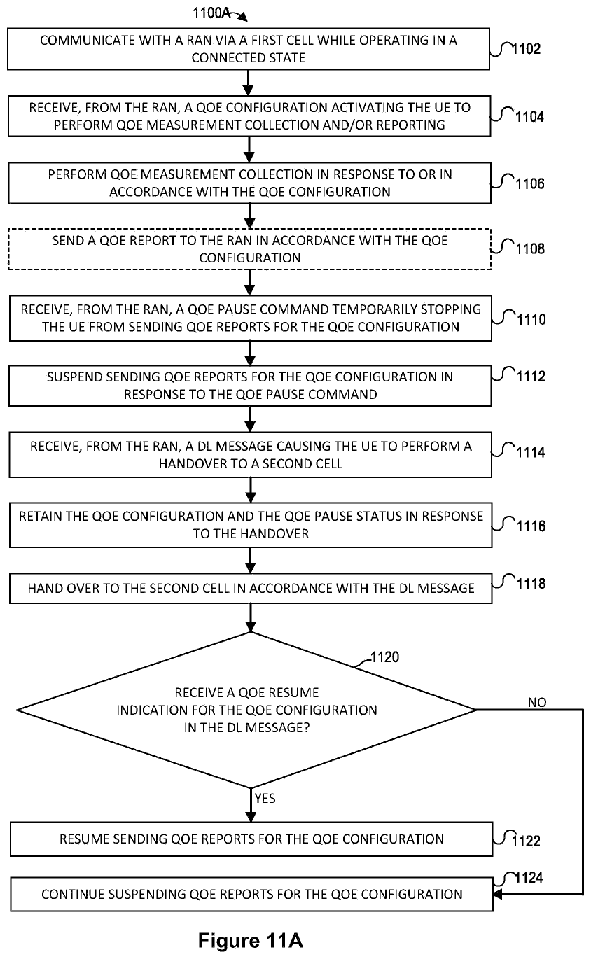

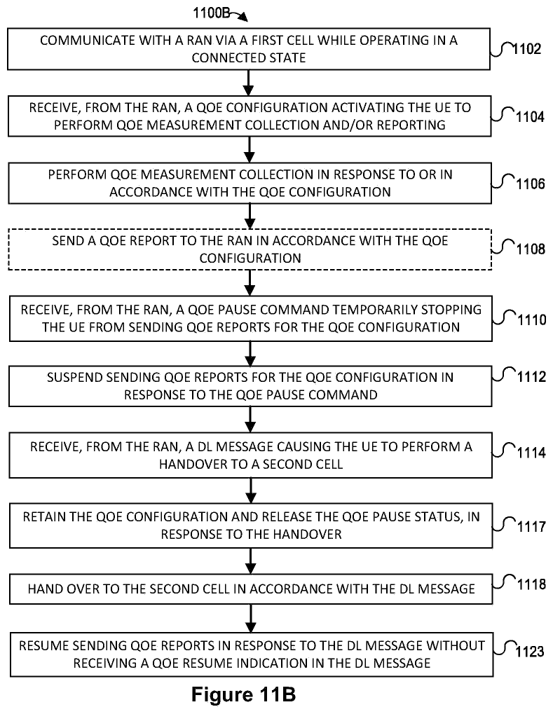

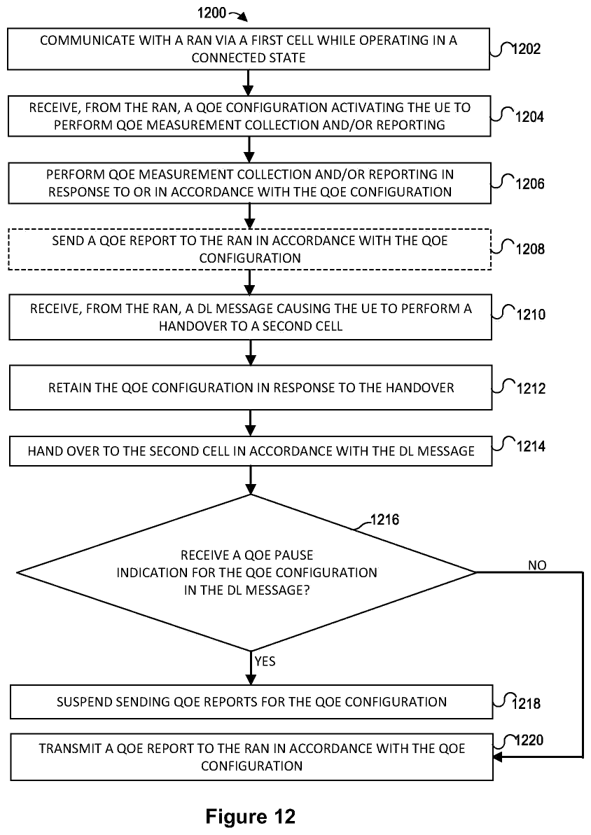

Referring now to FIG. 12, a method 1200 can be implemented in a suitable UE and includes determining whether to pause QoE reporting or continue in accordance with a QoE configuration based on whether the UE receives a QoE pause indication for the QoE configuration. For clarity, the method 1200 is discussed with specific reference to the RAN 105 and the UE 102.

At block 1202, the UE 102 communicates with a RAN 105 via a first cell while operating in a connected state (e.g., event 384 of FIGS. 3D-3J). At block 1204, the UE 102 receives a QoE configuration from the RAN 105 (e.g., event 384 of FIGS. 3D-3J). The QoE configuration activates QMC and reporting for the UE 102 (e.g., event 384 of FIGS. 3D-3J). At block 1206, the UE 102 performs QMC and reporting in accordance with the QoE configuration (e.g., event 384 of FIGS. 3D-3J). In some implementations, the flow continues to block 1208. At block 1208, the UE 102 transmits a QoE report to the RAN 105 in accordance with the QoE configuration (e.g., event 384 of FIGS. 3D-3J).

Then, at block 1210, the UE 102 receives a downlink message from the RAN 105, causing the UE 102 to perform a handover to a second cell (e.g., events 385/386 of FIGS. 3D-3F and 3I-3J; event 325 of FIGS. 3G-3H). At block 1212, the UE 102 retains the QOE configuration and at block 1214, the UE 102 performs a handover to the second cell in accordance with the downlink message (e.g., events 385/386 of FIGS. 3D-3F and 3I-3J or events 325/360/328 of FIGS. 3G-3H). At block 1216, the UE 102 determines whether the UE 102 receives a QoE pause indication for the QoE configuration in the downlink message (e.g., event 364 of FIG. 3I). If the UE 102 determines that the UE 102 does receive a QoE pause indication, then the flow proceeds to block 1218. At block 1218, the UE 102 pauses QoE reporting for the QoE configuration (e.g., event 354 of FIG. 3I). If the UE 102 determines that the UE 102 does not receive a QoE pause indication, then the flow proceeds to block 1220. At block 1220, the UE 102 transmits a QoE report to the RAN 105 in accordance with the QoE configuration.

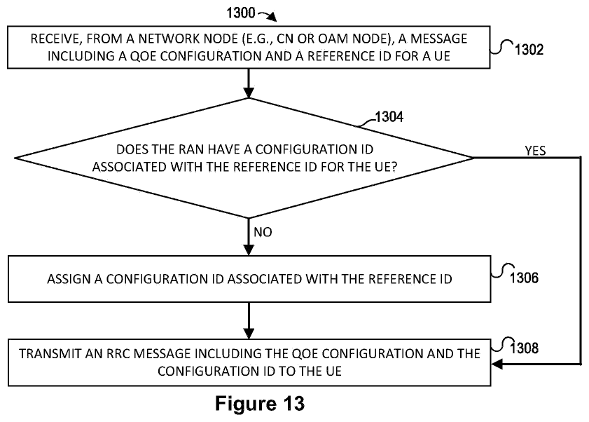

Referring now to FIG. 13, a method 1300 can be implemented in a suitable RAN and includes determining whether to assign a QoE configuration identifier to a reference identifier based on whether the RAN has a configuration identifier for the reference identifier. For clarity, the method 1300 is discussed with specific reference to the RAN 105, the CN 110 or OAM 180 as a QoE node, and the UE 102.

At block 1302, a RAN 105 receives a message including a QoE configuration and a reference ID for a UE 102 from a CN 110 or an OAM 180 node (e.g., events 306 or 384 of FIGS. 3A-3C). At block 1304, the RAN 105 determines whether the RAN 105 has a configuration ID associated with the reference ID. If the RAN 105 does not have a configuration ID associated with the reference ID, then the flow proceeds to block 1306, where the RAN 105 assigns a configuration ID to the reference ID (e.g., events 307 or 384 of FIGS. 3A-3C). The flow then proceeds to block 1308. If the RAN 105 does have a configuration ID associated with the reference ID, then the flow proceeds directly to block 1308, where the RAN 105 transmits an RRC message including the QoE configuration and the configuration ID to the UE 102 (e.g., events 308 or 384 of FIGS. 3A-3C). In some implementations, the message at block 1302 includes a first QoE pause indication for the QoE configuration. Subsequently, at block 1308, the RAN 105 includes a second QoE pause configuration for the QoE configuration in the RRC message.

Referring now to FIG. 14, a method 1400 can be implemented in a suitable RAN and includes determining whether to activate QoE reporting or update a QoE configuration, and subsequently whether to send QoE reports for the updated QoE configuration based on whether the UE receives a pause indication, a resume indication, or no status indication. For clarity, the method 1400 is discussed with specific reference to the RAN 105 and the UE 102.

At block 1402, a UE 102 receives an RRC message including a first QoE configuration and a QoE configuration ID from a RAN 105 (e.g., events 308 or 384 of FIGS. 3A-3J). At block 1404, the UE 102 determines whether the UE 102 has a second QoE configuration associated with the QoE configuration ID (e.g., event 345 of FIG. 3B). If the UE does not have a second QoE configuration associated with the QoE configuration ID, then the flow proceeds to block 1406, where the UE 102 activates QMC and reporting in accordance with the first QoE configuration (e.g., events 344 or 390 of FIGS. 3B-3C). If the UE 102 does have a second QoE configuration associated with the QoE configuration ID, then the flow proceeds to block 1408. At block 1408, the UE 102 updates or replaces the second QoE configuration with the first QoE configuration (e.g., events 343 or 390 of FIGS. 3B-3C). At block 1410, the UE 102 then activates (or reactivates) QMC in accordance with the updated QoE configuration (e.g., events 343 or 390 of FIGS. 3B-3C).

Next, at block 1412, the UE 102 determines whether the RRC message further includes a QoE pause indication, a QoE resume indication, or no status indication for the second QoE configuration. If the UE 102 determines that the RRC message includes a QoE pause indication, then the flow continues to block 1416, where the UE 102 refrains from transmitting QoE reports for the updated QoE configuration. If the UE 102 determines that the RRC message includes a QoE resume indication, then the flow continues to block 1418, where the UE 102 transmits a QoE report for the updated QoE configuration to the RAN 105 (e.g., events 312 or 384 of FIGS. 3A-3J; events 344 or 390 of FIGS. 3B-3C). If the UE 102 determines that the RRC message does not include a status indication, then flow continues to decision block 1414, where the UE 102 determines whether the first QoE configuration is paused. If the first QoE configuration is paused, then the flow continues to block 1416. If the first QoE configuration is not paused, then the flow continues to block 1418.

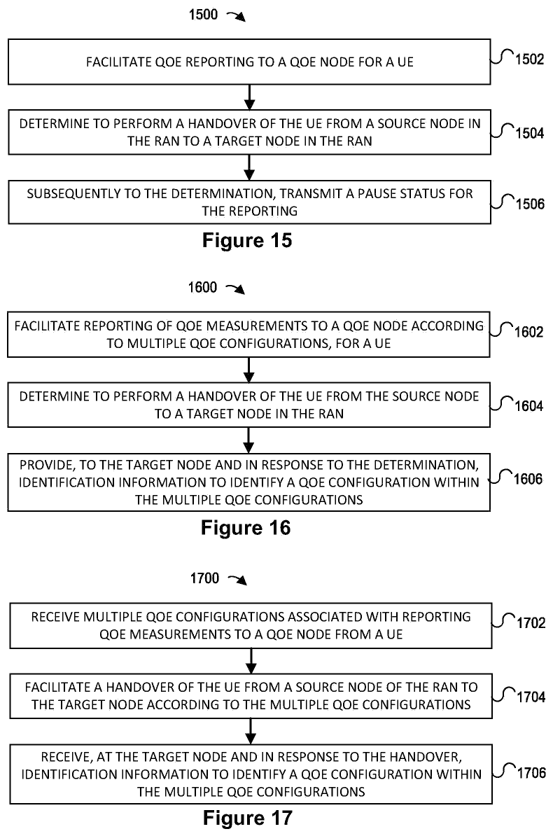

Referring now to FIG. 15, a method 1500 is a method in a RAN 105 or another suitable RAN for managing QoE reporting.

At block 1502, the RAN 105 facilitates QoE reporting to a CN 110 or OAM 180 for a UE 102 (e.g., events 384, 402/404, 602/604, 702/704, 1002/1004, or 1302 of FIGS. 3A-3J, 4A-4B, 6, 7, 10, and 13). At block 1504, the RAN 105 determines to perform a handover of the UE 102 from a source base station 104 to a target base station 106 (e.g., events 316/385/386, 412, 502, 708, 802, 902, or 1010 of FIGS. 3A-3J, 4A-4B, 5, 7, 8A-8B, 9, and 10). At block 1506, the RAN 105, subsequently to determining to handover the UE 102, transmits a pause status for the QoE reporting at the UE 102 (e.g., events 352/391/392, 358/396, 610, 714/722/724, 802/803/804/812, 910, or 1008 of FIGS. 3D-3J, 6, 7, 8A-8B, 9, and 10).

Referring now to FIG. 16, a method 1600 can be implemented in a source base station 104 or another suitable source node in a RAN for managing QoE reporting.

At block 1602, a source base station 104 facilitates reporting of QoE measurements to a CN 110 or an OAM node 180 according to multiple QoE configurations, for a UE 102 (e.g., events 384, 402/404, 502/504, or 1302 of FIGS. 3A-3C, 4A-4B, 5, and 13). At block 1604, the source base station 104 determines to perform a handover of the UE from the source base station 104 to a target base station 106 (e.g., events 316/385/386 or 412 of FIGS. 3A-3C and 4). At block 1606, the source base station 104 provides, to the target base station 106 and in response to the determining, identification information to identify a QoE configuration within the multiple QoE configurations (e.g., events 320/386, 318/319/385, 414/416, or 415/417 of FIGS. 3A-3C and 4A-4B).

Referring now to FIG. 17, a method 1700 can be implemented in a target base station 106 or another suitable target node in a RAN for managing QoE reporting.

At block 1702, a target base station 106 receives multiple QoE configurations associated with QoE reporting to a CN 110 or OAM 180 from a UE 102 (e.g., 320/386, 318/319, 385, or 502 of FIGS. 3A-3C and 5). At block 1704, the target base station 106 facilitates a handover of the UE 102 from a source base station 104 to the target base station 106 according to the multiple QoE configurations (e.g., events 386/385 or 502/508 of FIGS. 3A-3C and 5). At block 1706, the target base station 106 receives, at the target base station 106 and in response to the handover, identification information to identify a QoE configuration of the multiple QoE configurations (e.g., events 338/339, 388, 390, or 512 of FIGS. 3A-3C and 5).

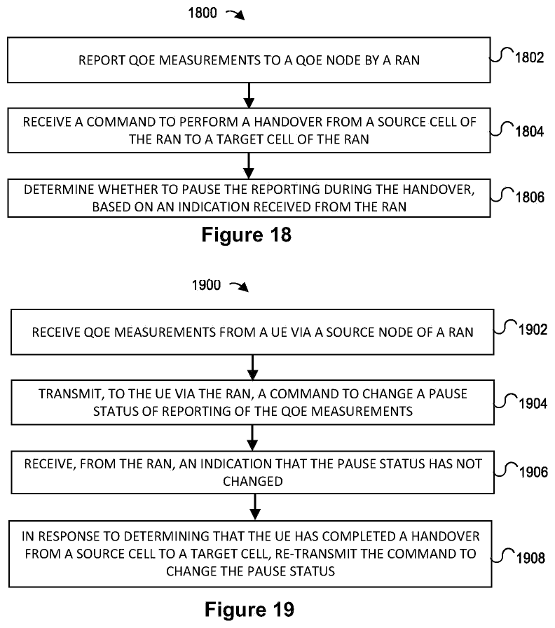

Referring now to FIG. 18, a method 1800 can be implemented in a UE 102 or another suitable UE for managing QoE reporting.

At block 1802, a UE 102 reports QoE measurements to a CN 110 or OAM 180 via a RAN 105 (e.g., events 312/314/384, 1108, or 1208 of FIGS. 3D-3J, 11A-11B, and 12). At block 1804, the UE 102 receives a command to perform a handover from a source cell of the RAN 105 to a target cell of the RAN 105 (e.g., events 325/385/386, 1114, or 1210 of FIGS. 3D-3J, 11A-11B, and 12). At block 1806, the UE 102 determines whether to pause the reporting during the handover, based on an indication received from the RAN 105 (e.g., events 352/354/391/392, 1110/1112, or 1216 of FIGS. 3D-3J, 11A-11B, and 12).

Referring now to FIG. 19, a method 1900 can be implemented in a CN 110 or OAM node 180, or another suitable QoE node for managing QoE reporting.

At block 1902, a CN 110 or OAM 180 receives QoE measurements from a UE 102 via a source base station 104 (e.g., event 384 of FIGS. 3D-3J). At block 1904, the CN 110 or OAM 180 transmits, to the UE 102 via the RAN 105, a command to change a pause status of reporting of the QoE measurements (e.g., events 350 or 368 of FIGS. 3I-3J). At block 1906, the CN 110 or OAM 180 receives, from the RAN 105, an indication that the pause status has not changed (e.g., event 358 of FIGS. 3I-3J). At block 1908, in response to determining that the UE 102 has completed a handover from a source cell to a target cell, the CN 110 or OAM 180 re-transmits the command to change the pause status (e.g., events 362 or 396 of FIGS. 3I-3J).

The following list of examples reflects a variety of the embodiments explicitly contemplated by the present disclosure:

Example 1. A method for managing quality of experience (QoE) reporting, the method implemented in a source node in a radio access network (RAN) and comprising: facilitating, by processing hardware, reporting of QoE measurements for a user equipment (UE), to a QoE node; determining, by the processing hardware, to perform a handover of the UE from the source node to a target node in the RAN; and subsequently to the determining, transmitting a pause status for the reporting.

Example 2. The method of example 1, further comprising: receiving, prior to performing the handover, a command to pause the reporting; wherein transmitting the pause status includes: transmitting, to the target node, a message related to the handover and including an indication that the reporting is paused.

Example 3. The method of example 2, further comprising: receiving, from the target node, a second message related to the handover and including a request to resume the reporting; transmitting, by the processing hardware to the UE, the request to resume the reporting.

Example 4. The method of example 1, further comprising: initiating, by the processing hardware and prior to performing the handover, a pause in the reporting; wherein transmitting the pause status includes: transmitting, by the processing hardware to the target node, a handover request message including an indication that the reporting is paused.

Example 5. The method of example 1, further comprising: initiating, by the processing hardware and prior to performing the handover, a pause in the reporting; wherein transmitting the pause status includes: transmitting, by the processing hardware to a core network, a handover required message including an indication that the reporting is paused.

Example 6. The method of example 1, wherein transmitting the pause status includes: transmitting, to the UE, a message including an indication that the reporting is resumed.

Example 7. The method of example 6, further comprising: receiving, prior to performing the handover, a command to pause the reporting; determining, by the processing hardware, to resume the reporting in response to determining to perform the handover.

Example 8. The method of example 6, further comprising: receiving, prior to performing the handover, a command to pause the reporting; transmitting, to the target node, a handover request message including an indication that the reporting is paused; and receiving, from the target node, a handover request acknowledgement message including a request to resume the reporting; wherein: transmitting the message including the indication that the reporting is resumed is in response to the handover request acknowledgement message.

Example 9. The method of example 6, further comprising: receiving, prior to performing the handover, a first command to pause the reporting; receiving, subsequently to the first command, a second command to resume the reporting; wherein: transmitting the message including the indication that the reporting is resumed is in response to the second command.

Example 10. The method of example 1, further comprising: receiving, from the QoE node and subsequently to determining to perform the handover, a command to pause the reporting; and refraining from pausing the reporting in response to the command; wherein: transmitting the pause status includes transmitting, to the QoE node, an indication that the reporting has not been paused.

Example 11. The method of example 1, further comprising: receiving, from the QoE node and subsequently to determining to perform the handover, a command to resume the reporting; and refraining from resuming the reporting in response to the command; wherein: transmitting the pause status includes transmitting, to the QoE node, an indication that the reporting has not been resumed.

Example 12. The method of any of examples 1-11, wherein transmitting the pause status for the reporting includes: transmitting an identifier of a QoE configuration to which the pause status pertains.

Example 13. The method of any of examples 1-12, wherein the facilitating includes: receiving, from the UE, one or more QoE reports; and in response to receiving the one or more QoE reports, transmitting, to the QoE node, the one or more QoE reports.

Example 14. The method of any of examples 1-12, wherein the facilitating includes: receiving, from the UE, one or more QoE reports; storing the one or more QoE reports; and in response to receiving an indication from the QoE node, transmitting, to the QoE node, the one or more QoE reports.

Example 15. A method for managing quality of experience (QoE) reporting, the method implemented in a source node in a radio access network (RAN) and comprising: facilitating, by processing hardware, reporting of QoE measurements to a QoE node according to a plurality of QoE configurations, for a user equipment (UE); determining, by the processing hardware, to perform a handover of the UE from the source node to a target node in the RAN; and providing, by the processing hardware to the target node and in response to the determining, identification information to identify a QoE configuration within the plurality of QoE configurations.

Example 16. The method of example 15, wherein the identification information includes: (i) one or more reference identifiers; (ii) one or more QoE configuration identifiers, each corresponding to a respective one of the plurality of QoE configurations; and (iii) a mapping between the one or more reference identifiers and the one or more QoE identifiers.

Example 17. The method of example 16, further comprising: receiving the one or more reference identifiers from the QoE node.

Example 18. The method of example 16, further comprising: generating the one or more reference identifiers at the source node.

Example 19. The method of any of examples 15-18, wherein the providing includes: transmitting, from the source node to the target node, a message related to the handover and including the identification information.

Example 20. The method of any of examples 15-18, wherein the providing includes: transmitting, from the source node to the QoE node, a message related to the handover and including the information to identify the QoE configuration, wherein the QoE node transmits, to the target node, the identification information.

Example 21. The method of any of examples 15-20, further comprising: receiving, at the source node from the QoE node, the identification information; receiving, from the QoE node, a reference identifier; and determining whether to release a QoE configuration based on whether the reference identifier matches a reference identifier included in the identification information.

Example 22. The method of any of examples 15-20, further comprising: receiving, at the source node from the QoE node, the identification information; and determining whether to setup or modify a QoE configuration based on whether the source node receives a reference identifier that matches an identifier included in the identification information.

Example 23. The method of any of examples 15-22, wherein the facilitating includes: receiving, from the UE at the source node, one or more QoE reports; and in response to receiving the one or more QoE reports, transmitting, to the QoE node, the one or more QoE reports.

Example 24. The method of any of examples 15-22, wherein the facilitating includes: receiving, from the UE at the source node, one or more QoE reports; storing the one or more QoE reports; and in response to receiving an indication from the QoE node, transmitting, to the QoE node, the one or more QoE reports.

Example 25. A method for managing quality of experience (QoE) reporting, the method implemented in a target node of a radio access network (RAN) and comprising: receiving, by the processing hardware, a plurality of QoE configurations associated with reporting QoE measurements to a QoE node from a user equipment (UE); facilitating, by the processing hardware, a handover of the UE from a source node of the RAN to the target node according to the plurality of QoE configurations; and receiving, by the processing hardware at the target node and in response to the handover, identification information to identify a QoE configuration within the plurality of QoE configurations.

Example 26. The method of example 25, further comprising: receiving, at the target node from the QoE node, a command to release a QoE configuration; identifying a QoE configuration ID for the QoE configuration based on the identification information; transmitting, to the UE, a radio resource reconfiguration message including a command to release the QoE configuration corresponding to the QoE configuration ID.

Example 27. The method of examples 25 or 26, further comprising: receiving, at the target node from the QoE node, a command to modify a QoE configuration; identifying a QoE configuration ID for the QoE configuration based on the identification information; and transmitting, to the UE, a radio resource reconfiguration message including a command to modify the QoE configuration associated with the QoE configuration ID.

Example 28. A radio access network (RAN) comprising processing hardware and configured to implement a method according to any of examples 1-27.

Example 29. A method for managing quality of experience (QoE) reporting, the method implemented in a user equipment (UE) and comprising: reporting, by processing hardware, QoE measurements to a QoE node via a radio access network (RAN); receiving, by the processing hardware, a command to perform a handover from a source cell of the RAN to a target cell in the RAN; and determining, by the processing hardware, whether to pause the reporting during the handover, based on an indication received from the RAN.

Example 30. The method of example 29, wherein the determining includes: pausing the reporting when the indication from the RAN includes a command to pause the reporting.

Example 31. The method of example 30, further comprising: receiving the indication prior to receiving a message related to the handover.

Example 32. The method of example 30 or 31, further comprising: resuming the reporting in response to receiving, in the target cell and subsequently to the handover, at least one of: (i) a QoE resume command or (ii) a QoE configuration.

Example 33. The method of example 30 or 31, further comprising: determining to resume the QoE reporting in response to determining that that the handover has completed.

Example 34. The method of example 29, wherein the determining includes: pausing the reporting when a message related to the handover includes a command to pause the reporting.

Example 35. The method of any of examples 29-34, further comprising: receiving, from the RAN, a configuration ID corresponding to a QoE configuration; and in response to determining that the UE does not have a stored QoE configuration corresponding to the configuration ID, activating the reporting according to the QoE configuration corresponding to the configuration ID.

Example 36. The method of any of examples 29-34, further comprising: receiving, from the RAN, a configuration ID corresponding to a first QoE configuration; and in response to determining that the UE has a stored second QoE configuration corresponding to the configuration ID, updating the second QoE configuration with the first QoE configuration.

Example 37. A user equipment (UE) comprising processing hardware and configured to implement a method according to any of examples 29-36.

Example 38. A method for managing quality of experience (QoE) reporting, the method implemented in a QoE node operating in, or in communication with, a core network (CN), the method comprising: receiving, by processing hardware, QoE measurements from a user equipment (UE) via a source node of a radio access network (RAN); transmitting, by the processing hardware to the UE via the RAN, a command to change a pause status of reporting of the QoE measurements; receiving, by the processing hardware from the RAN, an indication that the pause status has not changed; and in response to determining that the UE has completed a handover from a source cell to a target cell, re-transmitting the command to change the pause status.

Example 39. The method of example 38, wherein the command is a pause command.

Example 40. The method of example 38, wherein the command is a resume command.

Example 41. A QoE node comprising processing hardware and configured to implement a method according to any of examples 38-40.

The following additional considerations apply to the foregoing discussion.

In some implementations, variables and functions are given names by example. It will be understood that such names are examples only. As such, depending on the implementation, variables and functions with similar features may be named differently.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing radio bearers through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for managing a quality of experience (QoE) reporting, which is implemented in a source node in a radio access network (RAN), the method comprising:
facilitating the QoE reporting of QoE measurements to a QoE node for a user equipment (UE) according to any one among a plurality of QoE configurations;
determining to perform a handover of the UE from the source node to a target node in the RAN; and
providing, to the target node, a reference identifier and a QoE configuration identifier to identify a QoE configuration within the plurality of QoE configurations, the reference identifier being mapped to the QoE configuration identifier in accordance with association information indicating a relationship between the QoE configuration identifier and the reference identifier.

2. The method of claim 1, wherein the providing includes:
transmitting, from the source node to the target node, a message related to the handover and including the reference identifier and the QoE configuration identifier.

3. The method of claim 1, wherein the providing includes:
transmitting, from the source node to the QoE node, a message related to the handover and including the reference identifier and the QoE configuration identifier, the message being transmitted to cause the QoE node to forward the reference identifier and the QoE configuration identifier to the target node.

4. The method of claim 1, wherein the reference identifier is a first reference identifier, the method further comprising:
receiving, from the QoE node, the reference identifier and the QoE configuration identifier;
receiving, from the QoE node, a second reference identifier; and
releasing the QoE configuration if the second reference identifier matches the first reference identifier.

5. The method of claim 1, wherein the association information includes a common RRC identifier mapped to the QoE configuration identifier and the reference identifier.

6. The method of claim 1, wherein the reference identifier is a first reference identifier, the method further comprising:
receiving, from the QoE node, the reference identifier and the QoE configuration identifier; and
setting up or modifying the QoE configuration if the source node receives a second reference identifier that matches the first reference identifier.

7. The method of claim 1, wherein the facilitating includes:
receiving, from the UE, one or more QoE reports; and
transmitting, to the QoE node, the one or more QoE reports in response to: (i) receiving the one or more QoE reports or (ii) receiving an indication from the QoE node.

8-10. (canceled)

11. A method for managing a quality of experience (QoE) reporting, which is implemented in a source node in a radio access network (RAN), the method comprising:
facilitating the QoE reporting of QoE measurements to a QoE node for a user equipment (UE);
determining to perform a handover of the UE from the source node to a target node in the RAN; and
transmitting a message related to the handover to the target node in the RAN and a pause status for the reporting.

12. The method of claim 11, further comprising:
performing the handover responsive to determining to perform the handover;
receiving, prior to performing the handover, a command to pause the reporting;
wherein transmitting the message related to the handover and the pause status includes:
transmitting, to the target node, the message related to the handover including an indication that the reporting is paused.

13. The method of claim 11, further comprising:
performing the handover responsive to determining to perform the handover;
initiating, prior to performing the handover, a pause in the reporting;
wherein transmitting the message related to the handover and the pause status includes:
transmitting, to the target node, a handover request message including an indication that the reporting is paused.

14. The method of claim 11, further comprising:
performing the handover responsive to determining to perform the handover;
receiving, prior to performing the handover, a command to pause the reporting;
determining to resume the reporting in response to determining to perform the handover.

15. The method of claim 11, further comprising:
performing the handover responsive to determining to perform the handover;
receiving, prior to performing the handover, a command to pause the reporting;
wherein transmitting the message related to the handover and the pause status includes:
transmitting, to the target node, a handover request message including an indication that the reporting is paused;
receiving, from the target node, a handover request acknowledgement message including a request to resume the reporting; and
transmitting a message including an indication that the reporting is resumed in response to receiving the handover request acknowledgement message.

16. The method of claim 11, further comprising:
receiving, prior to performing the handover, a first command to pause the reporting;
receiving, subsequently to the first command, a second command to resume the reporting; and
transmitting a message including an indication that the reporting is resumed in response to the second command.

17. An apparatus, operating as a source node of a radio access network (RAN) and configured for managing a quality of experience (QoE) reporting, the apparatus comprising:
processing hardware configured to:
facilitate the QoE reporting of QoE measurements to a QoE node for a user equipment (UE) according to any one among a plurality of QoE configurations;
determine to perform a handover of the UE from the source node to a target node in the RAN; and
provide, to the target node, a reference identifier and a QoE configuration identifier to identify a QoE configuration within the plurality of QoE configurations, the reference identifier being mapped to the QoE configuration identifier in accordance with association information indicating a relationship between the QoE configuration identifier and the reference identifier.

18. The apparatus of claim 17, wherein providing the reference identifier and the QoE configuration identifier includes:
transmitting, from the source node to the target node, a message related to the handover and including the reference identifier and the QoE configuration identifier.

19. The apparatus of claim 17, wherein providing the reference identifier and the QoE configuration identifier includes:
transmitting, from the source node to the QoE node, a message related to the handover and including the reference identifier and the QoE configuration identifier, the message being transmitted to cause the QoE node to forward the reference identifier and the QoE configuration identifier to the target node.

20. The apparatus of claim 17, wherein the reference identifier is a first reference identifier, and the processing hardware is further configured to:
receive, from the QoE node, the reference identifier and the QoE configuration identifier;
receive, from the QoE node, a second reference identifier; and
release the QoE configuration if the second reference identifier matches the first reference identifier.

21. The apparatus of claim 17, wherein the association information includes a common RRC identifier mapped to the QoE configuration identifier and the reference identifier.

22. The apparatus of claim 17, wherein the reference identifier is a first reference identifier, and the processing hardware is further configured to:
receive, from the QoE node, the reference identifier and the QoE configuration identifier; and
set up or modify the QoE configuration if the source node receives a second reference identifier that matches the first reference identifier.

23. The apparatus of claim 17, wherein facilitating the QoE reporting includes:
receiving, from the UE, one or more QoE reports; and
transmitting, to the QoE node, the one or more QoE reports in response to: (i) receiving the one or more QoE reports or (ii) receiving an indication from the QoE node.
